(19) United States
(12) Patent Application Publication
(10) Pub. No.: US 2016/0105508 A1
(43) Pub. Date: Apr. 14, 2016

(54) INFORMATION PROCESSING APPARATUS, DATA PROCESSING SYSTEM AND DATA PROCESSING MANAGEMENT METHOD

(71) Applicant: FUJITSU LIMITED, Kawasaki-shi (JP)

(72) Inventors: Masumi Ito, Yokohama (JP); Tomohiro Kawasaki, Yokohama (JP); Toshio Takeda, Machida (JP); Junichi Yamazaki, Mishima (JP)

(21) Appl. No.: 14/875,331

(22) Filed: Oct. 5, 2015

(30) Foreign Application Priority Data
Oct. 14, 2014 (JP) 2014-209829

(51) Int. Cl. H04L 29/08; H04L 12/18

(52) U.S. Cl. CPC H04L 67/1095; H04L 67/2842; H04L 12/18

(57) ABSTRACT

A process includes sending a first pre-notification that includes a processing start time of the first process and information about processing target data of the first process; determining whether or not it is feasible to commit the first process, according to a response with respect to the first pre-notification; and generating and transmitting, when a second pre-notification is received, a response to the second pre-notification according to whether or not each of the processes started in corresponding data processing unit earlier than a processing start time specified from the second pre-notification is targeted at processing target data specified from the second pre-notification and also according to performance information for a data processing unit.

### CROSS-REFERENCE TO RELATED APPLICATIONS

This application is based upon and claims the benefit of priority of the prior Japanese Patent Application No. 2014-209829, filed on Oct. 14, 2014, the entire contents of which are incorporated herein by reference.

### FIELD

The embodiments disclosed herein are related to an information processing apparatus, a data processing system, a data processing management program, and a data processing management method.

### BACKGROUND

After the Great East Japan Earthquake, techniques for the replication of data via a Wide Area Network (WAN) (hereinafter, referred to as the WAN replication technique) have become more important due to the need for business continuity in the event of a disaster. As the operation formats of the WAN replication technique at the data center (DC), there are an “Active/Mirror” type and an “Active/Active” type, for example. Between them, the trend is shifting to the “Active/Active” type with which replication between multiple sites is performed as multi-master, from the viewpoint of the effective use of DC resources.

With the WAN replication technique, the functions are often provided in a closed manner within the same type of products, for example between Database (DB) servers and between cache servers. In addition, in many cases, unidirectional replication is performed in which one of the DB server and the cache server becomes the master and the other becomes the slave.

However, the characteristics as master data are different between the cache server being the master as a processing result of the Online Transaction Processing (OLTP) and the DB server being the master for data accumulated from the past used for a purpose such as the Online Analytical Processing (OLAP). For this reason, there has been a demand from users of systems equipped with both the DB application and the cache application to handle both the cache server and the DB server as the master. In this case, bidirectional replication is to be performed between the cache server and the DB server.

As a procedure for synchronizing data within the same DC and between different DCs, a procedure is possible in which, after transactions are executed respectively with the DB server and the cache server, the transactions are committed after examining whether there is any conflict.

Meanwhile, techniques described in the respective documents below have been known.

Japanese Laid-open Patent Publication No. 05-197604

Japanese Laid-open Patent Publication No. 09-16453

### SUMMARY

According to an aspect of the embodiment, a non-transitory computer-readable recording medium having stored therein a data processing management program executed by a computer in a data processing system including a plurality of data processing apparatuses each of which includes a data processing unit and executes a data processing management program that operates in an associated manner with the data processing unit, respectively, the data processing units of the respective data processing apparatuses performing data updating in a linked manner in the data processing system, the data processing management program causing the computer to execute a process including detecting a completion of a first process with respect to a first processing request to a corresponding data processing unit; sending, according to the detection, a first processing completion pre-notification that includes a processing start time of the first process and information about processing target data of the first process to each of other management processes executed by other data processing management programs in the computer or in a specific data processing apparatus that is one of the plurality of data processing apparatuses; determining whether or not it is feasible to commit the first process, according to a response content with respect to the first processing completion pre-notification from each of a plurality of the management processes; and generating and transmitting, when a second processing completion pre-notification is received from one of the plurality of management processes, a response to the second processing completion pre-notification according to whether or not, in the corresponding data processing unit, each of the processes started in the corresponding data processing unit earlier than a processing start time specified from the second processing completion pre-notification is targeted at processing target data specified from the second processing completion pre-notification and also according to performance information stored in the first data processing apparatus for a data processing unit corresponding to the management process that transmits the second processing completion pre-notification.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of the flow of processing in a model in which WAN replication is performed between DCs only for the cache layer.

FIG. 2 illustrates an example of the flow of processing in a model in which WAN replication is performed between DCs for the cache layer and the DB layer.

FIG. 3 illustrates an example of processes in a comparison example 3.

FIG. 4 illustrates an example of the configuration of a data processing system according to an embodiment.

FIG. 5 illustrates an example (1) of the configuration of a data processing system according to an embodiment and the flow of processing.

FIG. 6 illustrates an example (2) of the configuration of a data processing system according to an embodiment and the flow of processing.

FIG. 7 illustrates an example (3) of the configuration of a data processing system according to an embodiment and the flow of processing.

FIG. 8 illustrates an example (4) of the configuration of a data processing system according to an embodiment and the flow of processing.

FIG. 9 illustrates an example of process exchanges between RPAs in chronological order.

FIG. 10 illustrates the flow of processing in a first pattern.

FIG. 11 illustrates the flow of processing in a second pattern.

FIG. 12 illustrates the flow of processing in a third pattern.

FIG. 13 illustrates the flow of processing in a fourth pattern.

FIG. 14 illustrates the flow of processing in a first pattern-1.

FIG. 15 illustrates the flow of processing in a first pattern-2.

FIG. 16 illustrates an example of the flow of processing in an embodiment.

FIG. 17 illustrates an example of the configuration of a data processing apparatus according to an embodiment.

FIG. 18 illustrates an example of the configuration of transaction management information.

FIG. 19 illustrates an example of the configuration of performance information.

FIG. 20 illustrates an example of the configuration of pre-notification management information.

FIG. 21 is an example (1) of a flowchart illustrating details of processing for the first transaction in a data processing apparatus according to an embodiment.

FIG. 22 is an example (2) of a flowchart illustrating details of processing for the first transaction in a data processing apparatus according to an embodiment.

FIG. 23 is an example (1) of a flowchart illustrating details of processing for the second transaction in a data processing apparatus according to an embodiment.

FIG. 24 is an example (2) of a flowchart illustrating details of processing for the second transaction in a data processing apparatus according to an embodiment.

FIG. 25 is an example of a flowchart illustrating details of the process of access control by a control unit.

FIG. 26 illustrates an example of a hardware configuration of a data processing apparatus.

FIG. 27 illustrates an example of the configuration of a data processing system according to an embodiment.

### DESCRIPTION OF EMBODIMENTS

There is a large difference in the processing speed between the DB server and the cache server. For example, the processing speed of the DB server is on the order of milliseconds, whereas the processing speed of the cache server is on the order of microseconds. In a case in which processing at the DB server is still being executed when processing at the cache server is finished, the cache server waits until the termination of the processing at the DB server, then checks whether there is any conflict, and commits the process after that. Accordingly, the processing performance of the cache server with a high processing speed is dragged down by the processing performance of the DB server with a low processing speed.

As a method for replication between data centers operated as Active/Active with both the DB server and the cache server being the master, there are techniques of the comparison example 1 and the comparison example 2 described below.

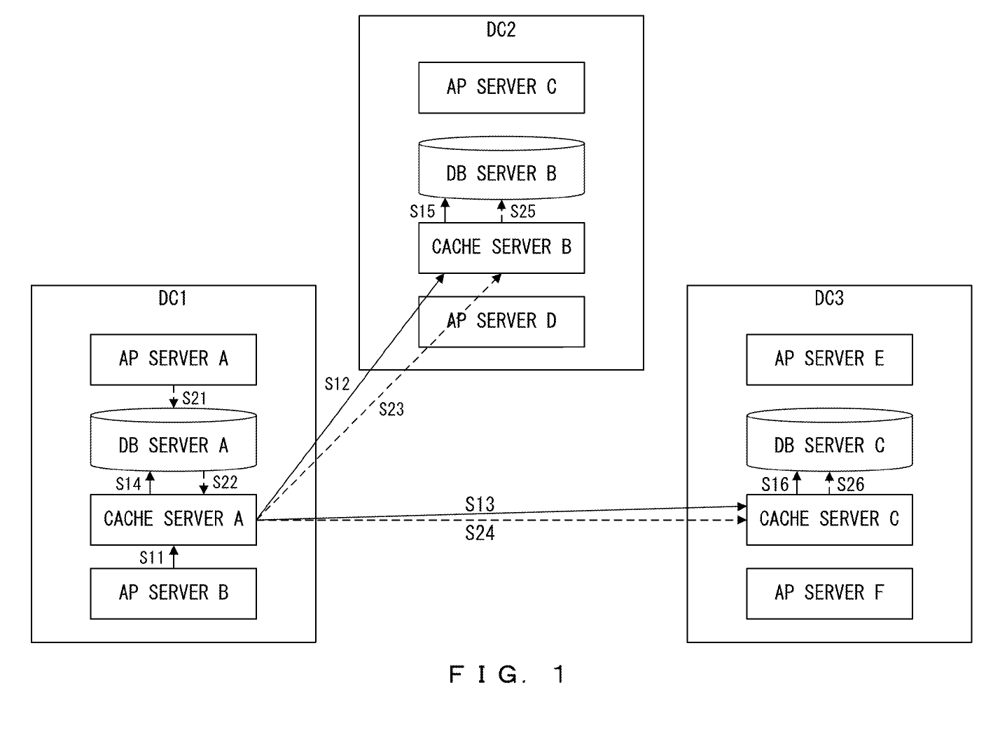

The comparison example 1 is a model in which WAN replication is performed between DCs only for the cache layer. FIG. 1 illustrates an example of the flow of processes in the model in which WAN replication is performed only for the cache layer between DCs. In FIG. 1, replication between cache servers (A-C) is performed, and therefore, when data of any of the cache servers (A-C) are updated, data of the other cache servers are also automatically updated. As a result, the cache servers (A-C) are constantly in a synchronized state.

In FIG. 1, S11-S16 illustrate the flow of processing in a case in which there is an update for the data in the cache server A by the application server (hereinafter, referred to as the AP server) B. When the data in the cache server A is updated by the AP server B (S11), synchronization by means of replication is performed between the cache servers (A-C) (S12, S13). After that, at a prescribed timing, a data synchronization process is performed between the cache server and the DB server in each DC (S14-S16). S21-S26 illustrate the flow of processing in a case in which there is an update for the data in the DB server A by the AP server A. When the data in the DB server A are updated by the AP server A (S21), a data synchronization process is performed at a prescribed timing between the DB server A and the cache server A (S22). Then, synchronization by means of replication is performed between the cache servers (A-C) (S23, S24). After that, at a prescribed timing, a data synchronization process is performed between the cache server and the DB server in each DC (S25, S26).

In FIG. 1, the data in the DB server are updated by one of the servers of the DC to which the DB server belongs and are never directly updated by a server belonging to another DC. In this case, between DCs, consistency of transactions is guaranteed between the cache servers but consistency of data is not guaranteed between the cache server and the DB server, and between DB servers.

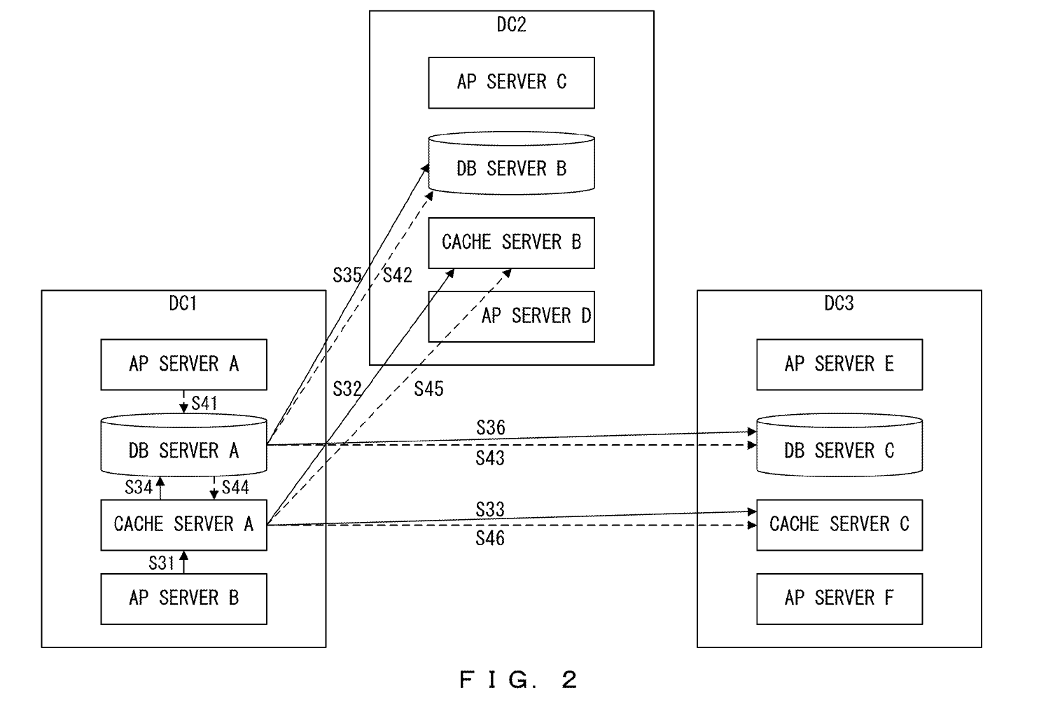

The comparison example 2 is a model in which WAN replication is performed between DCs respectively for the cache layer and the DB layer. FIG. 2 illustrates an example of the flow of processes in the model in which WAN replication is performed between DCs for the cache layer and the DB layer. In FIG. 2, replication is performed respectively between cache servers (A-C) and between the DB servers (A-C), and therefore, when data of any of the cache servers (A-C) are updated, data of the other cache servers are also automatically updated. As a result, the cache servers (A-C) are constantly in a synchronized state. In addition, when data of any of the DB servers (A-C) are updated, data of the other DB servers are also automatically updated. As a result, the DB servers (A-C) are constantly in a synchronized state.

In FIG. 2, S31-S36 illustrate the flow of processing in a case in which there is an update for the data in the cache server A by the AP server B. When the data in the cache server A is updated by the AP server B (S31), synchronization by means of replication is performed between the cache servers A-C(S32, S33). After that, at a prescribed timing, a data synchronization process is performed between the cache server A and the DB server A (S34), and synchronization by means of replication is performed between the DB servers (A-C) (S35, S36). S41-S46 illustrates the flow of processing in a case in which there is an update for the data in the DB server A by the AP server A. When the data in the DB server A are updated by the AP server A (S41), synchronization by means of replication is performed between the DB servers (A-C) (S42, S43). After that, at a prescribed timing, a data synchronization process is performed between the cache server A and the DB server A (S44), and synchronization by means of replication is performed between the cache servers A-C(S45, S46).

In the case of the example of FIG. 2, between DCs, consistency of transactions is guaranteed between the cache servers and between the DB servers, but consistency of data is not guaranteed between the cache server and the DB server.

As described above, in both the cases of the comparison example 1 and the comparison 2, consistency of data is not guaranteed between the cache server and the DB server. Accordingly, according to the techniques in the comparison example 1 and the comparison example 2, when both the cache server and the DB server are the master, an access from the cache server side and an access from the DB server side to the same data may bring about different results.

As a replication technique for guaranteeing consistency of data between the cache server and the DB server, there is a technique in a comparison example 3 in which replication using distributed transactions is performed.

In the comparison example 3, the processing of transactions is executed respectively to the DB server and the cache server, and then transactions are committed after examining whether there is any conflict. Accordingly, consistency of data is guaranteed between the cache server and the DB server.

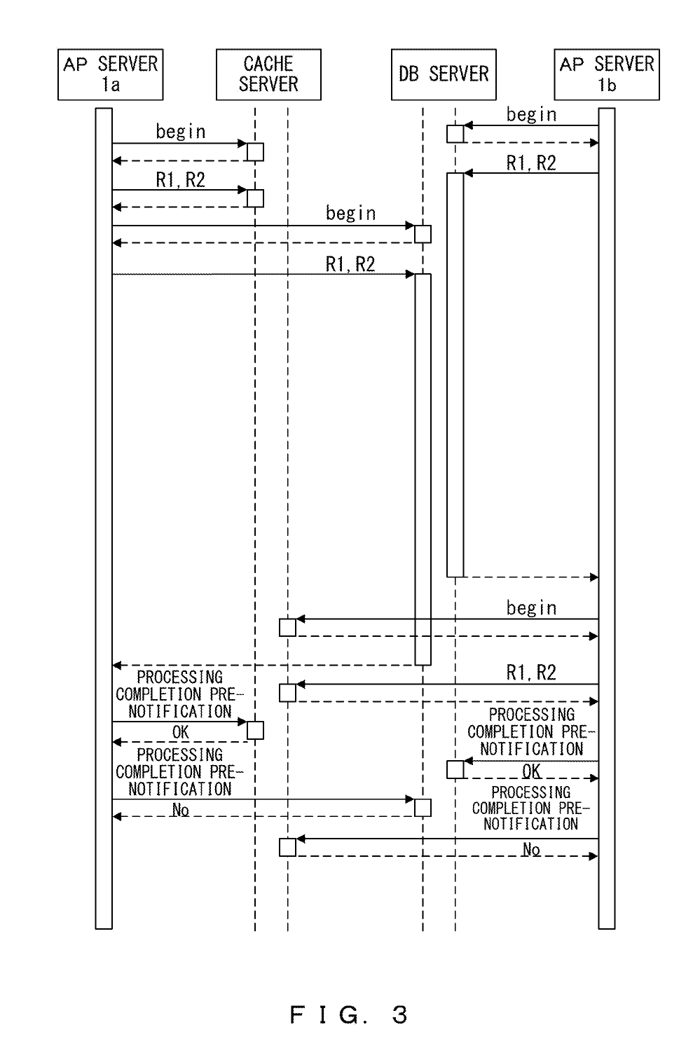

FIG. 3 illustrates an example of the flow of processing in the comparison example 3. In FIG. 3, an AP server 1a and an AP server 1b execute processing of transactions for the cache server and the DB server, respectively. The AP server 1a executes processing with the cache server first and executes processing with the DB server after that. Meanwhile, the AP server 1b executes processing with the DB server first and executes processing with the cache server after that. In addition, the transactions with the AP server 1a and the AP server 1b handle the same resources R1 and R2. Both the AP server 1a, 1b transmit a processing completion pre-notification for inquiring whether or not the committing of the process is feasible, after the processing of the transactions is finished with both the cache server and the DB server. Whether or not the committing of the process is feasible is determined according to whether or not a conflict has occurred between two transactions, and whether or not the transaction is a transaction for which the processing was started first between the transactions between which the conflict has occurred.

As illustrated in FIG. 3, upon transmitting a processing completion pre-notification to the cache server, the AP server 1a receives, as a response to it, a response that indicates that the commit is feasible. This is because, in the cache server, the processing with the AP server 1a was executed earlier than the processing with the AP server 1b. In a similar manner, upon transmitting a processing completion pre-notification to the DB server, the AP server 1b receives, as a response to it, a response that indicates that the commit is feasible. Meanwhile, upon transmitting a processing completion pre-notification to the DB server, the AP server 1a receives, as a response to it, a response that indicates that the commit is not feasible. This is because, in the DB server, the processing with the AP server 1b was executed earlier than the processing with the AP server 1a. In a similar manner, upon transmitting a processing completion pre-notification to the cache server, the AP server 1b receives, as a response to it, a response that indicates that the commit is not feasible.

In the comparison example 3, consistency of data is guaranteed by committing the process for both the cache server and the DB server when a response that indicates that the committing of the process is feasible is received from both the servers. However, as illustrated in FIG. 3, there may be a case in which both the AP server 1a, 1b receive a response that indicates that the committing of the process is not feasible with respect to processing completion pre-notifications to the cache server and the DB server, from one of these servers. In this case, both the AP server 1a, 1b are to execute a rollback of the transaction.

In addition, the AP servers 1a, 1b transmit the processing completion pre-notification after the processing is finished for both the cache server and the DB server. Therefore, the transaction conflict detection in the cache server is dragged down and delayed by the processing performance of the DB server. This causes a failure in which the throughput of the in-memory cache does not improve even with a scale-out of the system. In addition, the sequential transaction control results in a situation in which rollbacks of the transactions for both the AP server 1a, 1b are prone to occur, leading to a possibility that rollbacks may occur many times in order to commit the processes. Furthermore, the respective transaction orders (the processing start, the processing completion pre-notification, the commit or the rollback) from the AP servers are in a synchronized manner, and therefore, the total time needed for the completion of the transactions linearly increases according to the increase in the number of the data processing apparatuses that are the targets of replication.

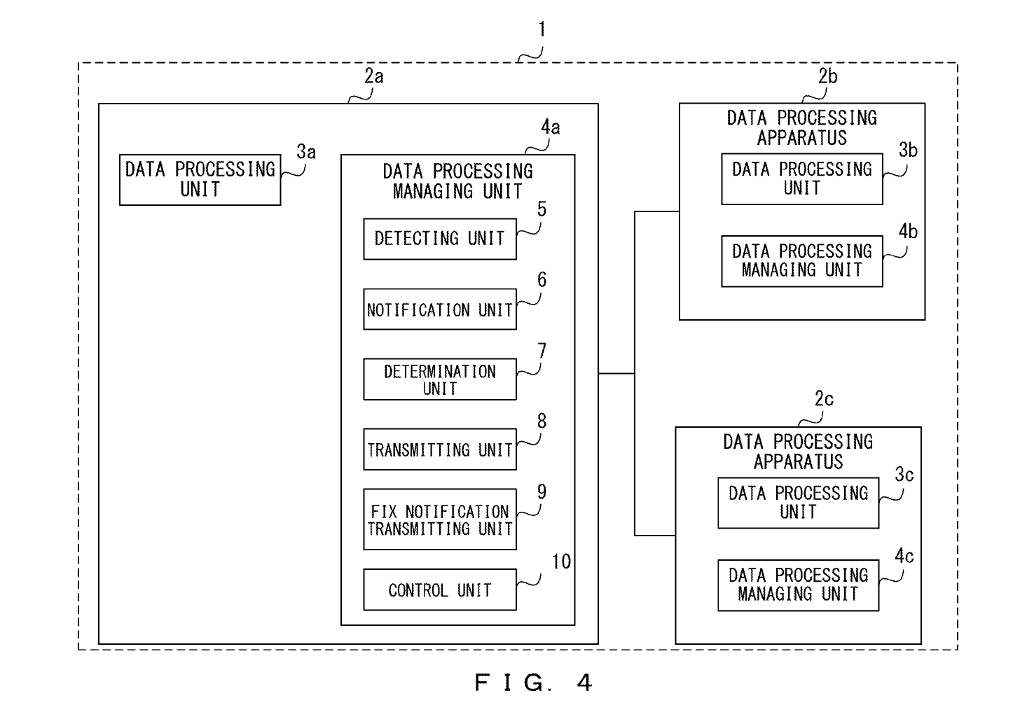

The configuration of a data processing system according to an embodiment is explained. FIG. 4 illustrates an example of the configuration of a data processing system according to an embodiment.

In FIG. 4, a data processing system 1 is equipped with a plurality of data processing apparatuses (2a-2c) that have data processing units (3a-3c) and data processing managing units (4a-4c) that operate in association with the data processing unit. Then, the respective data processing units (3a-3c) of the data processing apparatuses (2a-2c) perform data updating in a linked manner. In the explanation of FIG. 4, the explanation focusses on the data processing apparatus 2a as the first data processing apparatus in the plurality of data processing apparatuses (2a-2c), while the configuration of the data processing apparatus 2b, 2c is similar to that of the data processing apparatus 2a. In addition, the number of the data processing apparatuses included in the data processing system 1 is not limited to three. In addition, the data processing system may also be configured so as to include a plurality of data centers, each of the data centers including a plurality of data processing apparatuses.

The data processing managing unit 4a of the first data processing apparatus 2a includes a detection unit 5, a notification unit 6, a determination unit 7, a transmitting unit 8, a fix notification transmitting unit 9, and a control unit 10.

The detection unit 5 detects the completion of a first process with respect to a first processing request with the corresponding data processing unit 3a.

The notification unit 6 issues, according to the detection by the detection unit 5, a processing completion pre-notification for a first process that includes the processing start time of the first process and information about the processing target data, to each of the other data processing managing units (4b-4c) in the first data processing apparatus 2a or in the other data processing apparatuses (2b-2c).

The determination unit 7 determines whether or not it is feasible to commit the first process, according to the content of the response to the processing completion pre-notification for the first process from each of the other data processing managing units (4b-4c).

When the transmitting unit 8 receives a processing completion pre-notification for a second process from one of the other data processing managing units (4b-4c), the transmitting unit 8 executes the following process. That is, the transmitting unit 8 generates and transmits a response to the processing completion pre-notification for the second process, according to whether or not, in the data processing unit 3a, each of the processes started in the corresponding data processing unit 3a before the processing start time specified from the processing completion pre-notification for the second process is targeted at the processing target data specified from the processing completion pre-notification for the second process, and according to the performance information stored in the first data processing apparatus 2a for the data processing unit corresponding to the data processing managing unit that sent the processing completion pre-notification for the second process.

Accordingly, in the embodiment, in a system in which data replication is performed between a plurality of data processing apparatuses, the process for which processing started first is committed, and a response in accordance with the processing performance is performed. Accordingly, it is possible to execute another process without waiting for the completion of the process execution in the data processing units of other data processing apparatuses. Accordingly, it becomes possible to prevent the timing of determination as to whether or not it is feasible to commit the process from being dragged down by the processing performance of the other data processing apparatuses. As a result, it becomes possible to improve the transaction processing performance in each of the data processing apparatuses and in the data processing system as a whole.

Meanwhile, the notification unit 6 uses multicast communication when sending the processing completion pre-notification for the first process. By using multicast communication, it becomes possible to simultaneously manage a plurality of data processing apparatuses to match the transmission timings of processing completion pre-notifications.

In addition, when the determination unit 7 receives a first response from the other data processing managing units (4b-4c), the determination unit 7 further controls the corresponding data processing unit 3a so as to set the processing target data of the first process back to the state before the start of the first process. The first response is a notification that indicates that one of the processes started in the other data processing apparatuses (2b-2c) before the processing start time of the first process specified from the processing completion pre-notification for the first process is targeted at the processing target data specified from the processing completion pre-notification for the first process. Accordingly, it becomes possible to prevent an inconsistency of data from occurring between the data processing apparatuses.

In addition, when the determination unit 7 receives a second response from another data processing managing unit (4b-4c), the control unit 7 further controls the corresponding data processing unit 3a so as to re-execute the first process after setting the processing target data back to the state before the start of the first process and executing a third process. Here, the third process is a process that is targeted at data that are different from the processing target data of the second process. Meanwhile, the second response indicates that one of the processes started in the other data processing apparatuses (2b-2c) before the processing start time of the first process specified from the processing completion pre-notification for the first process is targeted at the processing target data specified from the processing completion pre-notification for the first process. In addition, the second response indicates that the performance of the corresponding data processing unit 3a is equal to or higher than the performance of the data processing units in the other data processing apparatus (2b-2c).

By making the third process that handles data that are different from the processing target data of the second process be executed while the second process is executed by another data processing unit with a low processing performance, the processing efficiency may be increased. In addition, accordingly, the possibility of the occurrence of a rollback may be reduced.

When the determination unit 7 determines that it is feasible to commit the first process, the fix notification transmitting unit 9 controls the data processing unit so as to perform the committing process for the first process, and transmits a commit notification indicating that the first process has been committed, to the other data processing managing units (4b-4c).

The control unit 10 performs the following process when, in the corresponding data processing unit 3a, each of the processes started before the processing start time specified from the processing completion pre-notification for the second process is not targeted at the processing target data specified from the processing completion pre-notification for the second process. That is, when a request for an access to the processing target data specified from the processing completion pre-notification for the second process is generated after transmitting a response to the processing completion pre-notification for the second process, the control unit 10 controls the corresponding data processing unit 3a so that the access is made after the commit notification corresponding to the second process is received and the committing process for the second process is executed.

According to the control by the control unit 10, it becomes possible to prevent other accesses to the processing target data specified from the processing completion pre-notification for the second process during the period between the transmission of the response to the processing completion pre-notification for the second process and the execution of the committing process for the second process. Accordingly, it becomes possible to prevent the occurrence of inconsistency of data between the data processing apparatuses.

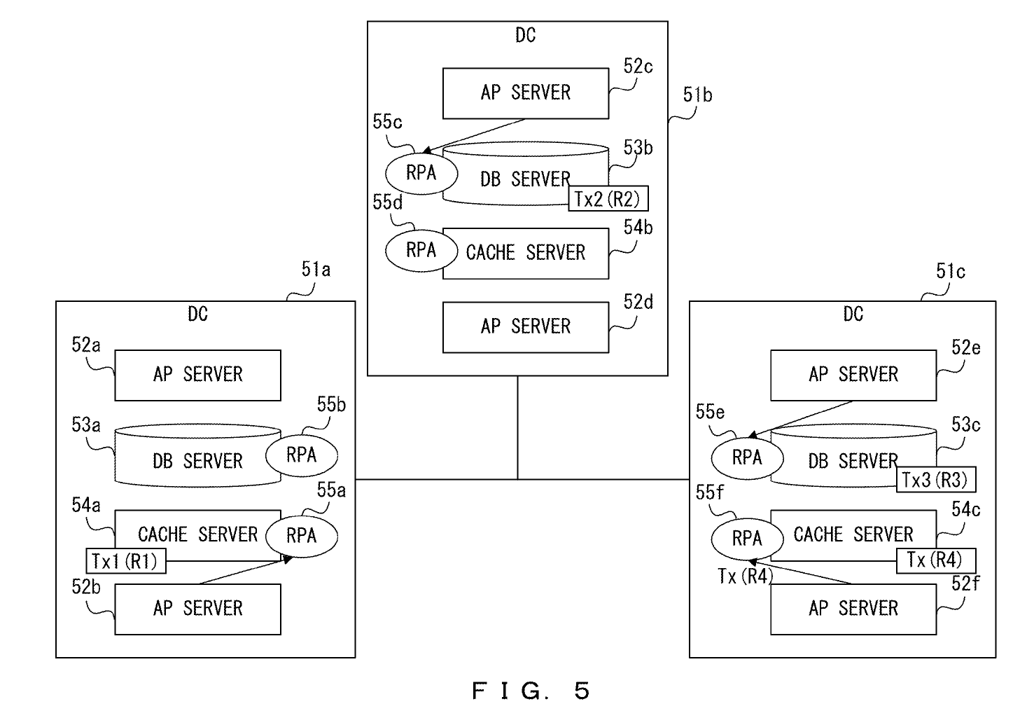

The overall configuration of the data processing system according to an embodiment and the flow of processing are explained. FIG. 5-FIG. 8 illustrate examples (1-4) of the configuration of the data processing system according to an embodiment and the flow of processing. FIG. 5-FIG. 8 illustrate changes in the processes in the data processing system in chronological order.

In the embodiment, when the processing of a transaction is finished in the data processing apparatus, an inquiry is made with the other data processing apparatuses as to whether or not it is feasible to execute a committing process, and according to the result of the response to it, a commit or a rollback is performed. In the explanation below, the inquiry as to whether or not it is feasible to execute a commit is referred to as a processing completion pre-notification.

In FIG. 5, the data processing system includes a plurality of DCs (DCs 51a-51c). The respective DCs are connected via a communication network. Each of the DCs includes AP servers 52(a-f), a DB server 53(a-c), and a cache server 54(a-c). The AP server 52, the DB server 53, and the cache server 54 are connected to each other via the communication network or a bus or the like.

In the data processing system, replication is performed between a plurality of DCs for the DB servers 53 and the cache servers 54. In the explanation below, the data processing apparatus that is the replication target may be referred to as a replication point (RP). The RP is, specifically, the DB server 53 and the cache server 54. On each RP runs Software (RPA) 55(a-f) that is a resident agent and that performs multicast transmission and reception. In multicast, a prescribed protocol such as the Reliable User Datagram Protocol (UDP) (RUDP) is used for example. The Reliable UDP supports the order assembly of arrived packets, the retransmission request, the disposal of duplicate packets, and the ACKnowledgement (ACK) response. The RP is an example of the data processing apparatus 2. The RPA is an example of the data processing managing unit 4.

The RPs respectively start transactions in an asynchronous manner. In FIG. 5, the RPA 55a is executing a transaction Tx(R1) with respect to the resource R1. Here, in the drawings and the explanation below, the transaction executed in the RP may be referred to in the format of “Txs (processing target data)” (s is an positive integer). The processing target data represent data that are updated or accessed in the corresponding transaction. The transaction with respect to the resource R1 is referred to as Tx1(R1). In addition, in FIG. 5, Tx2(R2), Tx3(R3), Tx4(R4) are executed in the RPA 55c, the RPA 55e, the RPA 55f, respectively.

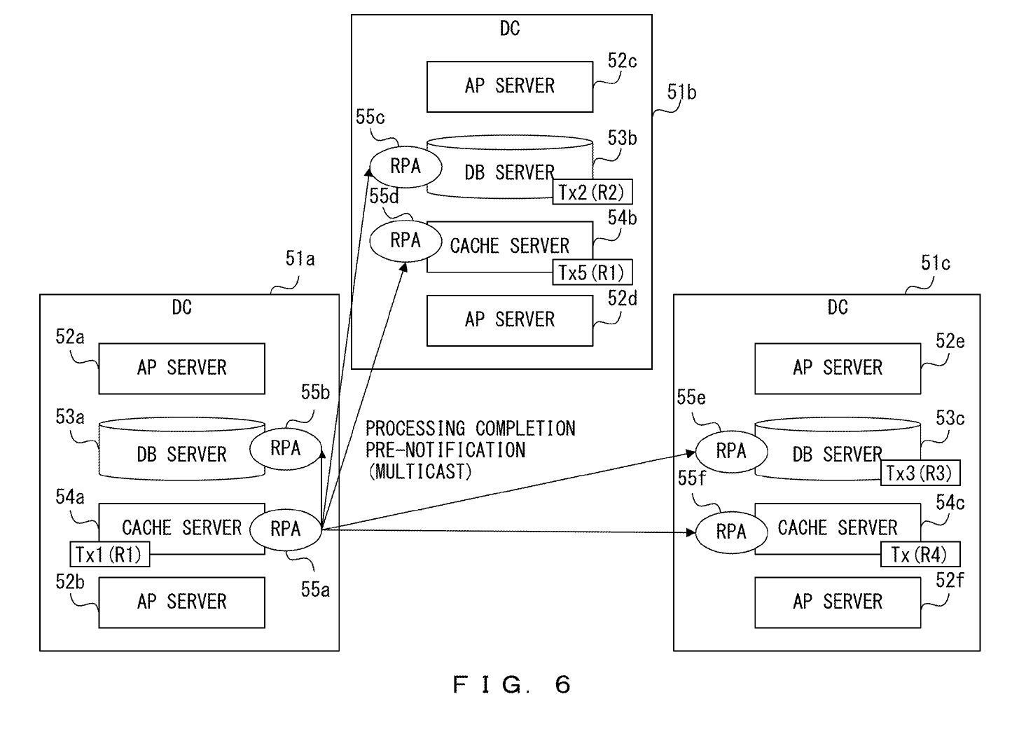

When the processing of a transaction is finished, the RP multicasts the processing completion pre-notification via the RPA before executing the commit for the transaction. In FIG. 6, the processing of the transaction Tx1(R1) is finished, and the RPA 55a multicasts the processing completion pre-notification to the other RPAs (55b-55f) just before the commit (or rollback) for the Tx1(R1) is performed.

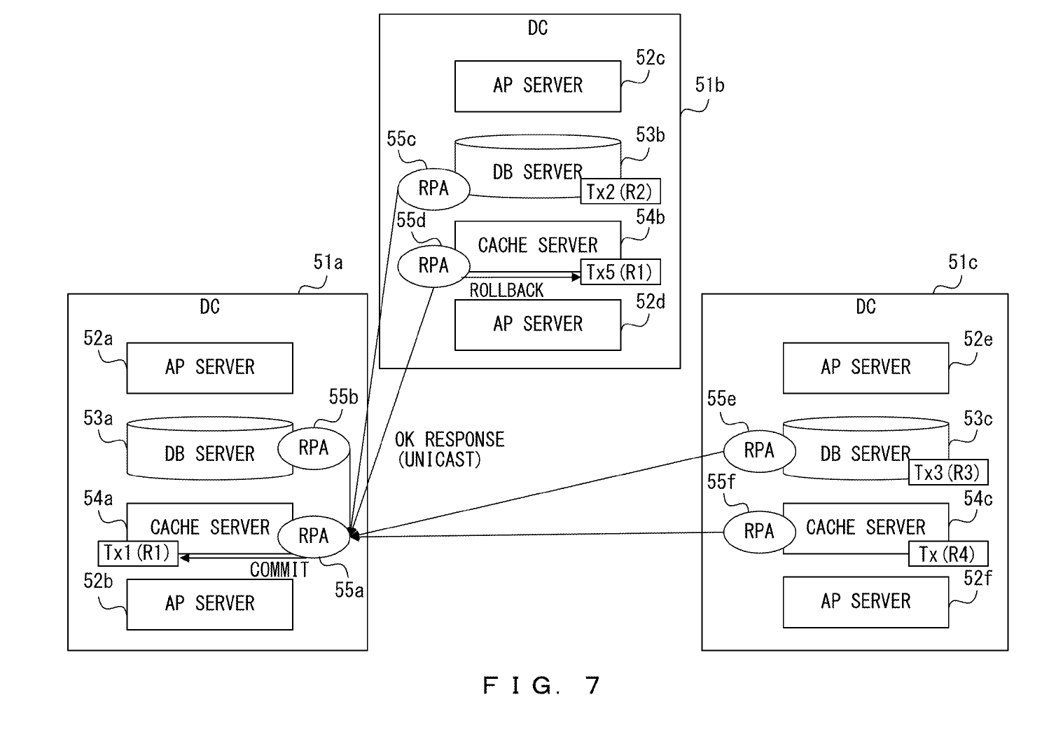

Each RPA that has received the processing completion pre-notification generates a response with respect to the processing completion pre-notification according to prescribed conditions and transmits it to the transmission-source RPA of the processing completion pre-notification. While this is explained in detail later, there are three types of responses with respect to the processing completion pre-notification, namely an OK response, a PENDING response, and a RETRY response. The prescribed conditions for determination are also explained layer. In FIG. 7, the RPAs (55b-55f) that have received the processing completion pre-notification generate a response to the processing completion pre-notification and transmit it to the RPA 55a. In the example of FIG. 7, an OK response that indicates that the commit is feasible is generated and transmitted.

Next, the transmission-source RPA of the processing completion pre-notification receives the responses with respect to the processing completion pre-notification, and according to the response result, decides whether to commit or to roll back the transaction. Then, according to this decision, the RPA performs control so as to execute the commit or rollback for the transaction. When executing the rollback, the RPA further decides whether to immediately execute the retry for the transaction or to delay it after the rollback, according to the response result. According to this decision, the RPA controls the process after the rollback. In FIG. 7, the RPA 55a that has received the OK responses with respect to the processing completion pre-notification decides to commit Tx1(R1) and performs control so as to execute the commit for Tx1(R1).

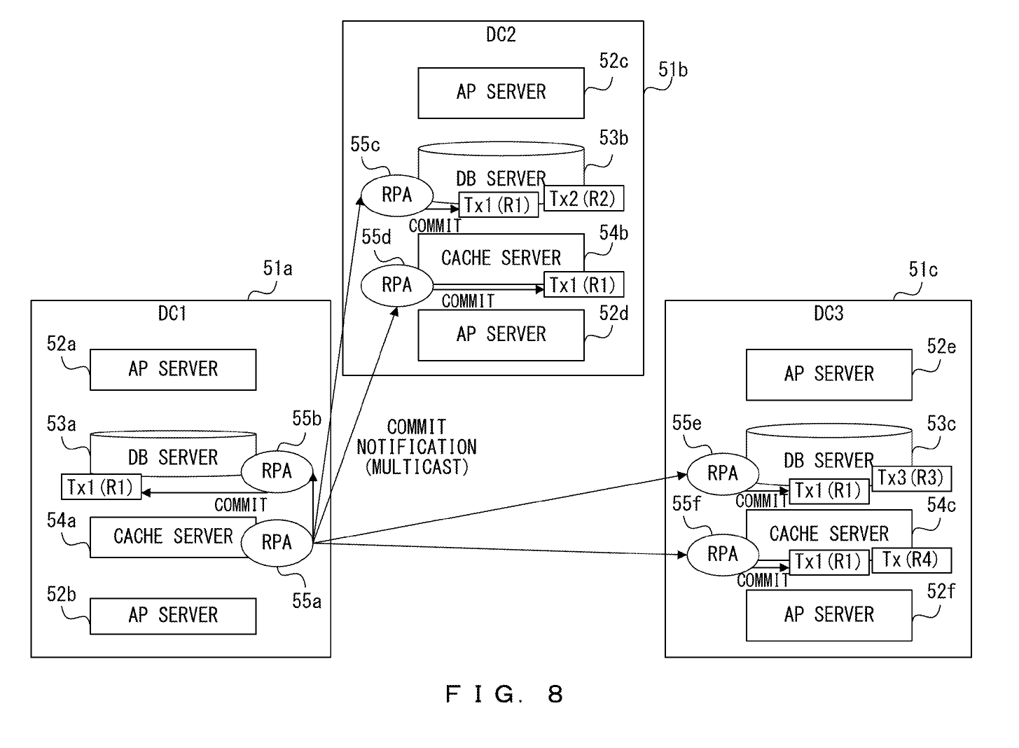

After the completion of the commit or rollback for the transaction, the RPA multicasts a commit notification or a rollback notification to the other RPAs. When an RPA receives a commit notification, the RPA performs control such that data are updated in consistency with the transmission source of the commit notification. In FIG. 8, the RPA 55a transmits a commit notification to each of the RPAs (55b-55f) when the commit of Tx1(R1) is completed. Then, the RPAs (55b-55f) that have received the commit notification update the data corresponding to Tx1(R1).

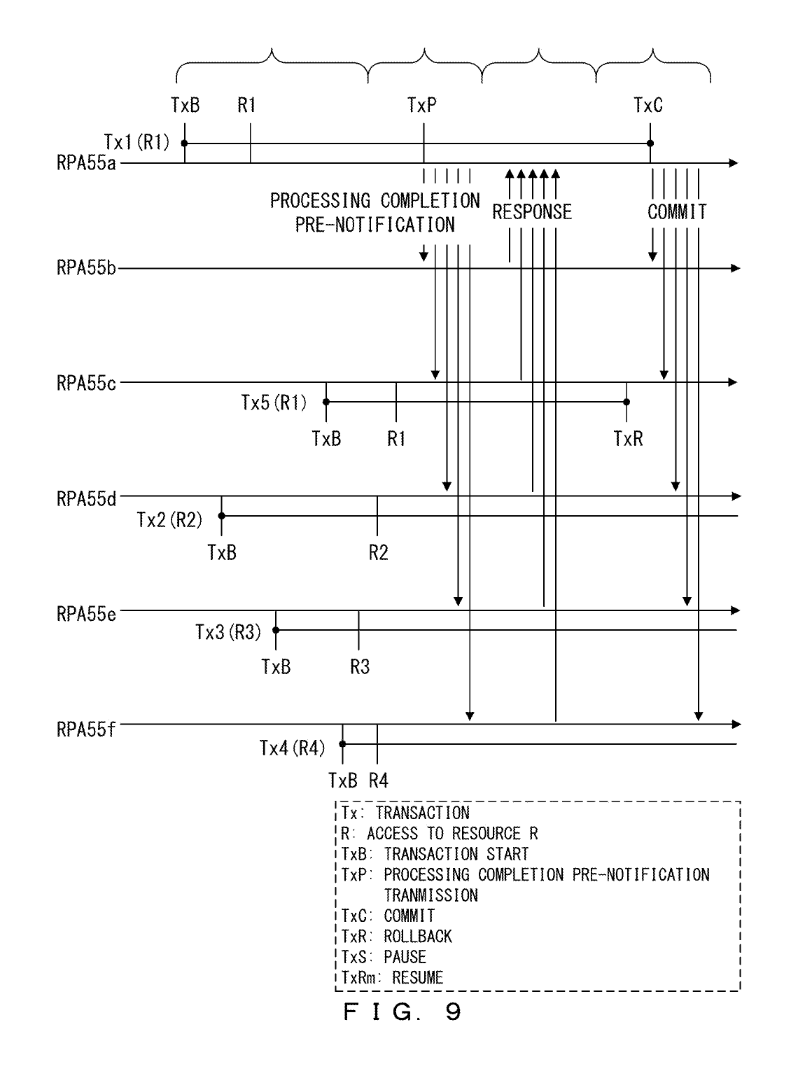

FIG. 9 illustrates the exchange of processes between the RPAs in FIG. 5-FIG. 8 in chronological order.

Here, an explanation is provided for the meanings of symbols used in FIG. 9 and FIG. 10-FIG. 15 explained below. Rr (r is a positive integer) indicates that an access to a resource Rr has occurred. TxB, TxP, TxC, TxR, TxS, TxRm indicate a point in time at which a transaction starts, a point in time at which the processing completion pre-notification is transmitted, a point in time at which a commit is executed, a point in time at which a rollback is executed, a point in time at which a process is paused, and a point in time at which a process is resumed, respectively.

In FIG. 9, in Tx1, the RPA1 accesses the resource R1, and multicasts the processing completion pre-notification when the processing of the transaction is finished at the point in time indicated as TxP. Each of the RPAs (55b-55f) that have received the processing completion pre-notification generates a response and transmits it to the RPA 55a. When the RPA 55a receives the responses, the RPA 55a performs a commit for the transaction and transmits a commit notification to the other RPAs (55b-55f).

In FIG. 5-FIG. 9 explained above, the transaction Tx1 is started earlier than all the transactions (Tx2-Tx5) executed in the other RPAs (55b-55f). In this case, each of the RPAs (55b-55f) generates an OK response that indicates that the execution of a commit is feasible as a response to the processing completion pre-notification from the RPA 55a and transmits it to the RPA 55a. However, for example, when Tx5 for accessing the resource R1 that is the same resource as for Tx1 has been started earlier than Tx1, the RPA 55c generates and transmits a RETRY response or a PENDING response that indicates that the execution of a commit is not feasible. Then, the RPA 55a that has received the response executes a rollback of Tx1. As descried above, in the embodiment, the flow of processing changes according to the processing target resources of transactions and the start time of transactions. Furthermore, the flow of processing in the embodiment also changes according to the transaction processing performance of the data processing apparatuses in which the respective RPAs operate.

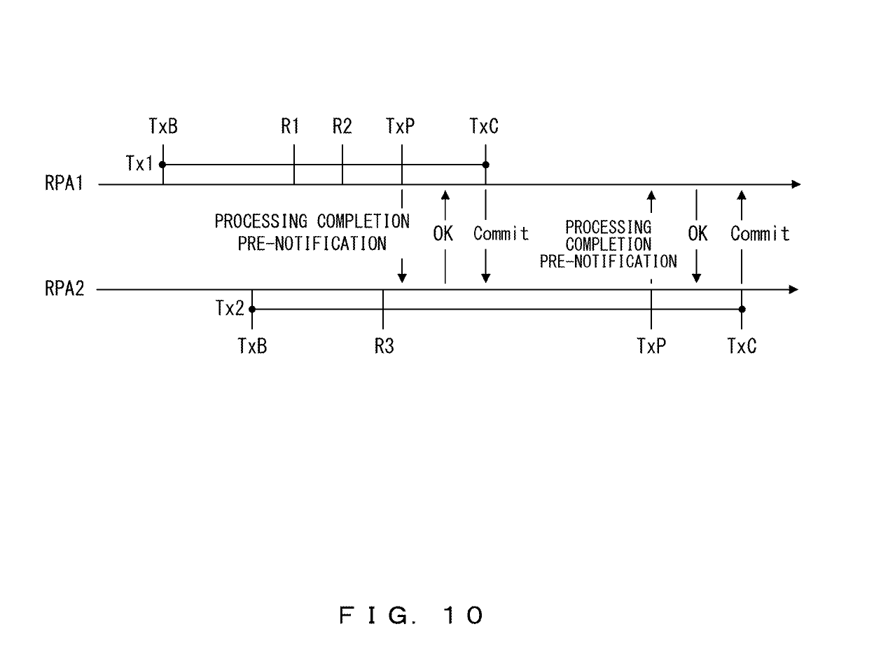

Hereinafter, the patterns of the flow of processing of transactions in the data processing system of the embodiment are explained. As the patterns of the flow of processing, there are four patterns, from the first through the fourth. Here, the patterns in the flow of processing are explained with reference to FIG. 10-FIG. 13 while focusing on the relationship between two RPAs, namely the RPA that transmits the processing completion pre-notification and the RPA that receives the processing completion pre-notification.

The first pattern is the pattern of processing in a case in which different resources are handled in transactions executed by the two RPAs of interest. No conflict occurs between the two transactions because the resources handled are different. Accordingly, a commit is feasible for both the transactions regardless of the processing of other transactions. FIG. 10 illustrates the flow of processing in the first pattern.

In FIG. 10, the RPA1 is the RPA that transmits a processing completion pre-notification first, and the RPA2 is the RPA that receives the processing completion pre-notification. In the transaction Tx1 executed in the RPA1, an access to resources R1, R2 has occurred, and in the transaction Tx2 executed in the RPA2, an access to the resource R3 has occurred. Therefore, the resources handled in Tx1 and Tx2 are different. In this case, the RPA2 that has received the processing completion pre-notification generates an OK response that indicates that the execution of a commit is feasible and transmits it to the RPA1. Upon receiving the OK response, the RPA1 executes a commit for the Tx1 and transmits a commit notification to the RPA2. Upon receiving the commit notification, the RPA2 reflects the content of Tx1.

The second through fourth patterns are all patterns in which there is the same resource in the resources handled in two transactions. Among these patterns, the second pattern is a pattern of processing in which the transaction that transmits the processing completion pre-notification is the preceding transaction. In the present embodiment, of the two transactions of interest, the transaction whose processing start time is earlier is referred to as a preceding transaction, and the transaction whose processing start time is later is referred to as a subsequent transaction.

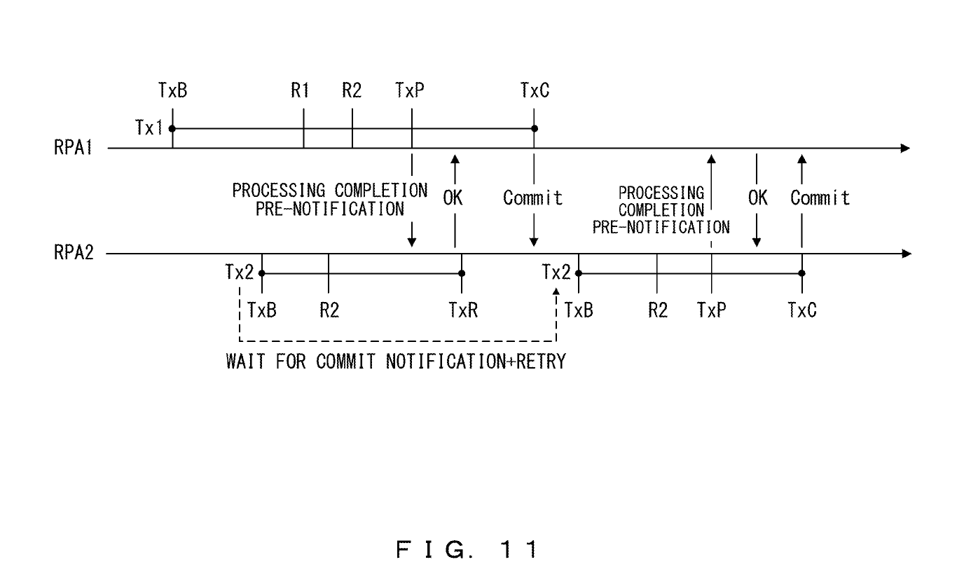

FIG. 11 illustrates the flow of processing in the second pattern. In FIG. 11, in the transaction Tx1 executed in the RPA1, an access to the resources R1, R2 has occurred, and in the transaction Tx2 executed in the RPA2, an access to the resource R2 has occurred. Therefore, in the resources handled in Tx1 and Tx2, R2 is the same. Meanwhile, the start time of Tx1 is earlier than that of Tx2.

In the second pattern, a conflict occurs between Tx1 and Tx2 because there is the same resource in the resources handled in the two transactions. In this case, a commit is executed with priority for Tx1, which is the preceding transaction, and a rollback is executed for Tx2, which is the subsequent transaction.

When the RPA2 receives the processing completion pre-notification from the RPA1, the RPA2 generates an OK response that indicates that the execution of a commit for Tx1 is feasible and transmits it to the RPA1, and also rolls back Tx2. The time from when the OK response is transmitted up to the completion of the commit for Tx1 is expected to be a short time, and therefore, the RPA2 executes Tx2 again after waiting for the commit notification that indicates that the commit in the RPA1 has been completed.

In the second pattern, specifically, the RPA2 that has received the processing completion pre-notification from the RPA1 generates an OK response and transmits it to the RPA1, and also executes a rollback for Tx2. After the rollback for Tx2, the RPA2 stops the processing for Tx2 until the commit notification for Tx1 is received. Meanwhile, when the RPA1 receives the OK response, the RPA1 executes a commit for Tx1, and transmits a commit notification to the RPA2. When the RPA2 receives a commit notification, the RPA2 reflects the content of Tx1, and executes Tx2 again.

The third and fourth patterns are both patterns of processing in a case in which there is the same resource in the resources handled in two transactions, and the transaction that transmits the processing completion pre-notification is the subsequent transaction. Of these patterns, the third pattern is pattern in which the transaction processing performance of the data processing apparatus that executes the subsequent transaction is equal to or lower than the transaction processing performance of the data processing apparatus that executes the preceding transaction.

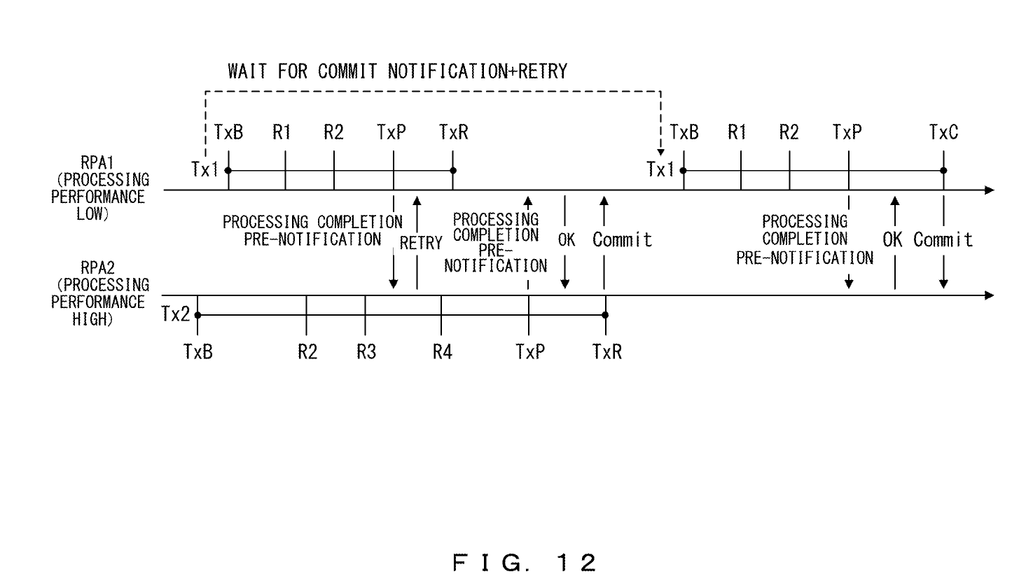

FIG. 12 illustrates the flow of processing in the third pattern. In FIG. 12, in the transaction Tx1 executed in the RPA1, an access to the resources R1, R2 has occurred, and in the transaction Tx2 executed in the RPA2, an access to the resources R2, R3, R4 has occurred. Therefore, in the resources handled in Tx1 and Tx2, R2 is the same. Meanwhile, the start time of Tx1 is later than that of Tx2. In addition, the transaction processing performance of the data processing apparatus in which the RPA1 operates is equal to or lower than the transaction processing performance of the data processing apparatus in which the RPA 2 operates.

In the third pattern, in the same manner as in the second pattern, a conflict occurs between Tx1 and Tx2 because there is the same resource in the resources handled in the two transactions. In this case, a rollback is executed for Tx1 that is the subsequent transaction, and a commit is executed with priority for Tx2 that is the preceding transaction.

When the RPA2 receives the processing completion pre-notification from the RPA1, the RPA2 generates a RETRY response that orders an immediate retry for Tx1, and transmits it to the RPA1. The reason for ordering the immediate retry here is that it is not likely that a conflict will occur again with the retry for the transaction in the RPA1 because the transaction processing performance of the RPA1 is equivalent to or lower than that of the RPA2. That is, it is because it is expected that the conflicting transaction in the RPA2 will have been completed when the RPA1 executes the retry. Accordingly, it becomes possible to reduce the possibility of recurrence of a conflict in a case when Tx1 is executed. Meanwhile, the RETRY response may also be regarded as indicating that a commit for Tx1 is not feasible.

The RPA1 that received the RETRY response rolls back Tx1. Meanwhile, the time from when the RETRY response is received until the completion of the commit for Tx2 is expected to be a short time compared with the processing time of another transaction in the RPA1 because the transaction processing performance of the RPA2 is higher than the transaction processing performance of the RPA1. Therefore, the RPA1 executes Tx1 again after waiting of the commit notification that indicates the completion of the commit in the RPA2.

In the third pattern, specifically, the RPA2 that has received the processing completion pre-notification from the RPA1 generates a RETRY response and transmits it to the RPA1 while continuing the processing for Tx2. Upon receiving the RETRY response, the RPA1 executes a rollback for Tx1, and stops the processing for Tx1 until the commit notification for Tx2 is received from the RPA2. The RPA2 transmits the processing completion pre-notification to the RPA1 as soon as the processing for Tx2 is completed. Then, when the RPA2 receives an OK response from the RPA1, the RPA2 executes a commit for Tx2, and transmits a commit notification to the RPA1. When the RPA1 receives the commit notification, the RPA1 reflects the content of Tx2, and after that, executes Tx1 again.

The fourth pattern is a pattern of processing in a case in which, as mentioned above, there is the same resource in the resources handled in two transactions, and also, the transaction that transmits the processing completion pre-notification is the subsequent transaction. Furthermore, the fourth pattern is a pattern of processing in a case in which the transaction processing performance of the data processing apparatus that executes the subsequent transaction is higher than the transaction processing performance of the data processing apparatus that executes the preceding transaction.

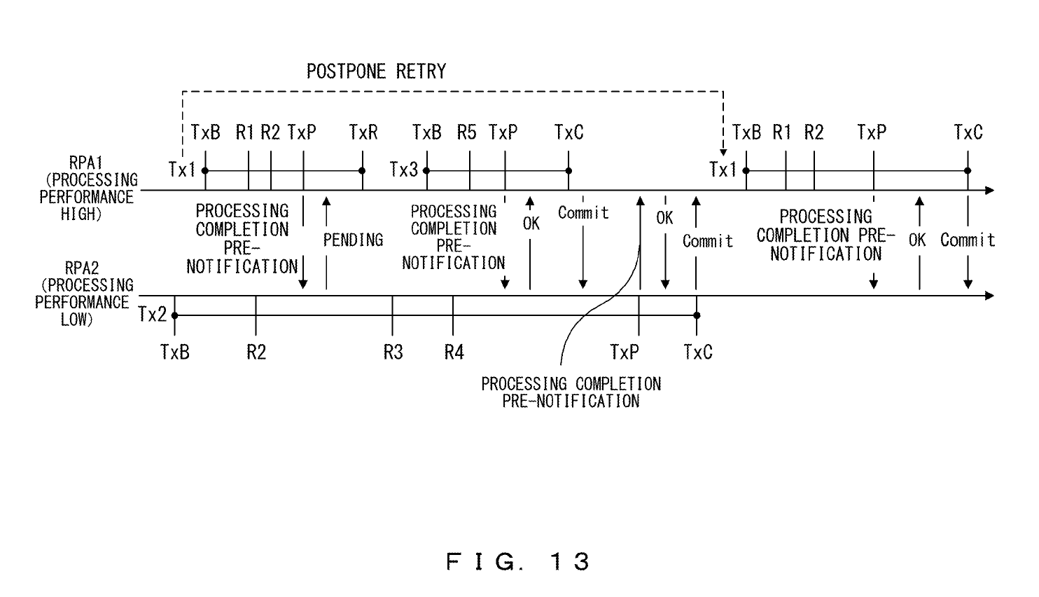

FIG. 13 illustrates the flow of processing in the fourth pattern. In FIG. 13, in the transaction Tx1 executed in the RPA1, an access to the resources R1, R2 has occurred, and in the transaction Tx2 executed in the RPA2, an access to the resources R2, R3, R4 has occurred. Therefore, in the resources handled in Tx1 and Tx2, R2 is the same. Meanwhile, the start time of Tx1 is later than that of Tx2. In addition, the transaction processing performance of the data processing apparatus in which the RPA1 operates is higher than the transaction processing performance of the data processing apparatus in which the RPA 2 operates.

In the fourth pattern, in the same manner as in the third pattern, a conflict occurs between Tx1 and Tx2 because there is the same resource in the resources handled in the two transactions. In this case, a rollback is executed for the subsequent transaction, TX1, and a commit is executed with priority for the preceding transaction, TX2.

When the RPA2 receives a processing completion pre-notification from the RPA1, the RPA2 generates a PENDING response and transmits it to the RPA1. The PENDING response is a response that includes content for ordering the processing for Tx1 to be pending and execution of a retry for Tx1 after execution of a transaction that handles a different resource. Here, the reason for ordering the processing for Tx1 to be pending is that if an immediate retry for Tx1 is executed, it is likely that Tx2 will not have been completed and the occurrence of the conflict will continue, because the transaction processing performance of the RPA1 is higher than that of the RPA2. Meanwhile, the PENDING response may also be regarded as indicating that a commit for Tx1 is not feasible.

The RPA1 that has received the PENDING response rolls back Tx1. Here, the transaction processing performance of the RPA2 is lower than that of the RPA1, and it is expected that a longer time will be needed until the completion of the commit for Tx2 compared with the transaction processing time for another transaction in the RPA1. By processing another transaction that can be processed during the time needed until the completion of Tx2, it becomes possible to increase the processing efficiency in the RPA1. Then, the RPA1 suspends the processing for Tx1 after executing the rollback for Tx1, and executes a transaction that handles a different resource. After that, the RPA1 executes Tx1 again after waiting for a commit notification that indicates the completion of the commit in the RPA2.

In the fourth pattern, specifically, the RPA2 that has received the processing completion pre-notification from the RPA1 generates a PENDING response and transmits it to the RPA1 while continuing the processing for Tx2. Upon receiving the PENDING response, the RPA1 executes a rollback for Tx1, and stops the processing for Tx1 until it receives the commit notification for Tx2 from the RPA2. After executing the rollback for Tx1, the RPA1 first processes a transaction Tx3 that does not handle the resources that are handled in Tx2. Meanwhile, the RPA2 transmits a processing completion pre-notification to the RPA1 as soon as the processing for Tx2 is finished. Then, when the RPA2 receives an OK response with respect to the processing completion pre-notification from the RPA1, the RPA 2 executes a commit for Tx2, and transmits a commit notification to the RPA1. When the RPA1 receives the commit notification, the RPA1 reflects the content of Tx2, and executes Tx1 again.

The first pattern is further categorized into two patterns, the first pattern-1 and the first pattern-2, according to the resource handled in the transaction that transmits the OK response after the transmission of the response.

In the transaction Tx2 that has transmitted an OK response, there is a possibility of the occurrence of an access to a resource handled in the transaction Tx1 that is the transmission source of the processing completion pre-notification, after the transmission of the OK response. There is a possibility of the occurrence of inconsistency when such an access is executed before the content of Tx1 is reflected after the reception of the commit notification for Tx1. Therefore, in the embodiment, different processes are provided for the case in which such an access occurs and for the case in which it does not. In the explanation below, the commit notification and the rollback notification may be collectively referred to as a process fix notification.

The first pattern-1 is a pattern of processing in a case in which, during the period from the time at which the OK response with respect to Tx1 is generated and before a process fix notification for Tx1 is received, no access occurs in Tx2 to the same resource as a resource handled in Tx1. Here, in a strict sense in the case in which the process fix notification is a commit notification in the explanation below, the period before a process fix notification is received refers to the period before the process for reflecting a transaction according to a received process fix notification is executed.

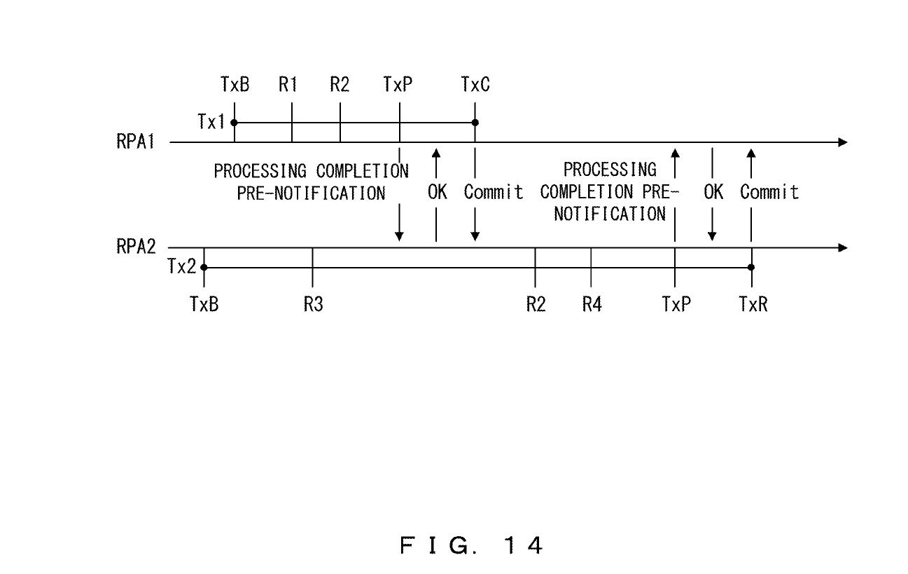

FIG. 14 illustrates the flow of processing in the first pattern-1. In FIG. 14, in the transaction Tx1 executed in the RPA1, an access to the resources R1, R2 has occurred. Then, in the transaction Tx2 executed in the RPA2, an access to the resource R3 occurs before a processing completion pre-notification is received, and an access to the resources R2, R4 occurs after a commit notification is received. Here, it is assumed that the RPA2 reflects the content of Tx1 simultaneously with the reception of the commit notification. Therefore, at the point in time at which the processing completion pre-notification is received, the resources handled in Tx1 and Tx2 are different. In addition, in the period from the transmission of the OK response and before the reception of the commit notification, no access occurs in Tx2 to the same resource as a resource handled in Tx1.

In this case, at the point in time at which the RPA2 receives the processing completion pre-notification for Tx1, there are no transactions that conflict with the transaction Tx1, and therefore, the RPA2 generates an OK response and transmits it to the RPA1. The RPA1 that has received the OK response executes a commit for Tx1, and transmits a commit notification to the RPA2. The RPA2 that has received the commit notification updates the resources corresponding to Tx1. After that, an access to the resources R2, R4 occurs in Tx2. Regarding the access to the resources R2, R4, the access to the resources R2, R4 is performed as it is, because reflection in the resources according to Tx1 has already been performed. Here, the resource R2 accessed by the RPA2 is guaranteed to be the R2 that has already been updated in transaction Tx1 in the RPA1.

The first pattern-2 is a pattern in a case in which, during the period from the time at which the OK response with respect to Tx1 is generated and before a process fix notification for Tx1 is received, an access occurs in Tx2 to the same resource as a resource handled in Tx1.

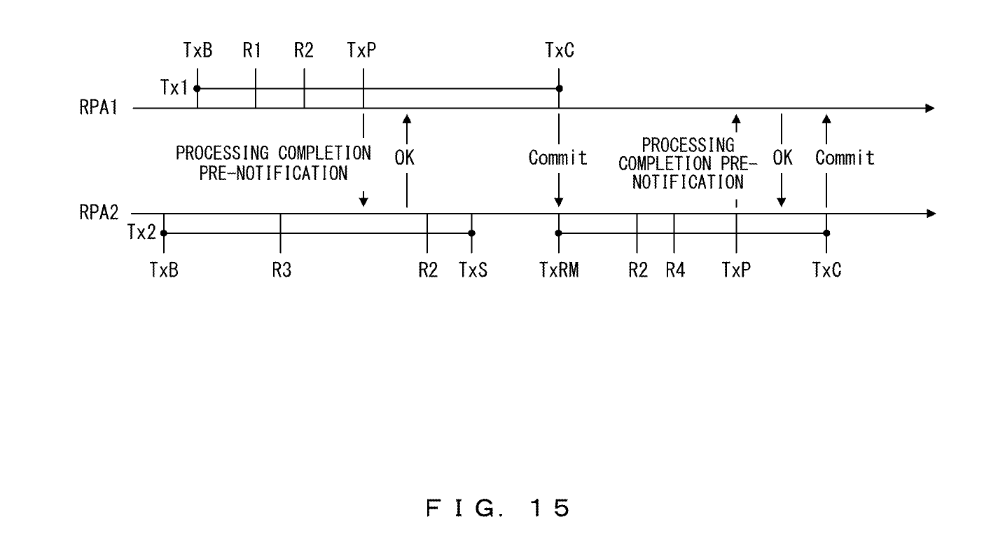

FIG. 15 illustrates the flow of processing in the first pattern-2. In FIG. 15, the processes between Tx1 and Tx2 up to the transmission of the OK response are similar to those in the first pattern-1. However, in the period from the transmission of the OK response until the reception of the commit notification, an access occurs in Tx2 to the resource R2 that has been handled in Tx1.

In this case, there is a possibility of the occurrence of inconsistency when the access to R2 is performed as it is, and therefore, the RPA2 pauses Tx2 just before the access to R2. Then, the RPA2 resumes Tx2 after receiving the commit notification for Tx1 and then performing resource update according to Tx1, and accesses the R2 that has been updated. By performing control in this way, it becomes possible to prevent the occurrence of inconsistency due to the access to the resource that has been handled in Tx1 occurring in the period from the time at which the OK response is generated and before a process fix notification for Tx1 is received.

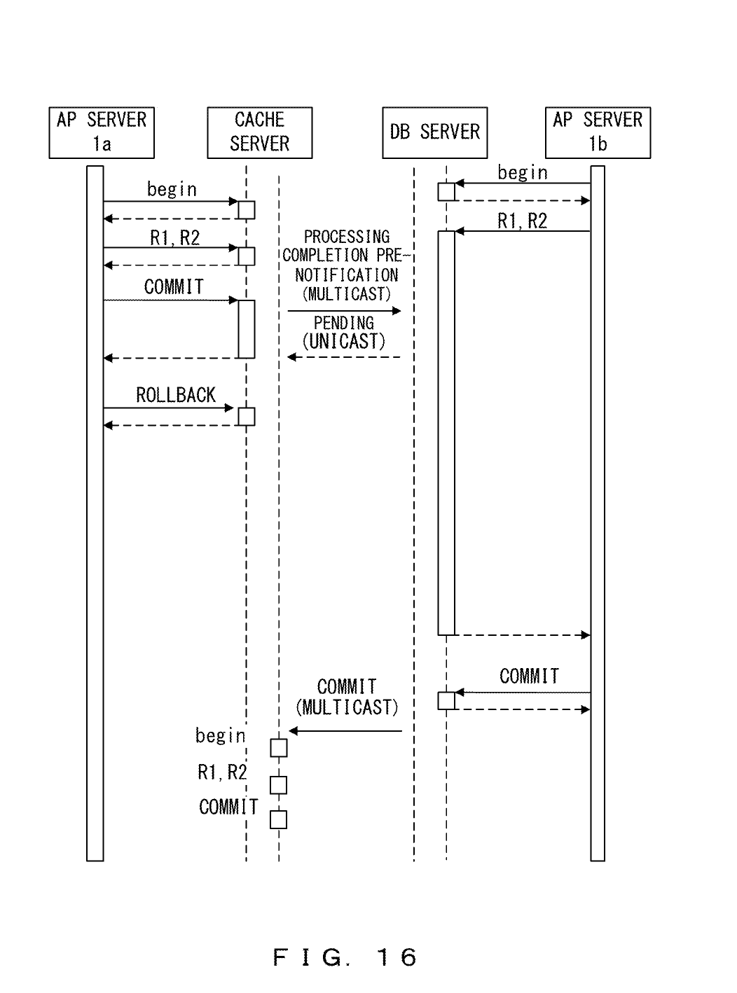

FIG. 16 illustrates an example of the flow of processing in an embodiment. In FIG. 16, an AP server 1b executes the processing of a transaction with the DB server. The AP server 1a executes processing of a transaction with the cache server after the start of the transaction in the AP server 1b. Meanwhile, the resources handled in the transactions in the AP server 1a and AP server 1b are the same resources R1 and R2.

In a manner that is different from that in FIG. 3, both the AP servers 1a, 1b transmit a processing completion pre-notification for inquiring whether or not the committing of the processing of each transaction is feasible every time the processing for the transaction with one of the cache server and the DB server is finished.

As illustrated in FIG. 16, when the transaction from the AP server 1a is finished, the cache server transmits a processing completion pre-notification to the DB server. As a response to this, in the case of the example of FIG. 16, a response that indicates that the committing of the process is not feasible comes from the DB server because the transaction in the DB server that handles the same resources R1, R2 has started earlier. Meanwhile, a PENDING response is sent here because the transaction processing performance of the cache server is higher than that of the DB server. Upon receiving the PENDING response, the cache serve rolls back the transaction. Thus, according to the embodiment, it becomes possible to prevent the conflict detection for transactions in the cache server from being dragged down and delayed by the processing performance of the DB server. Meanwhile, in FIG. 16, processes such as the transmission of the processing completion pre-notification in the DB server are omitted from the description.

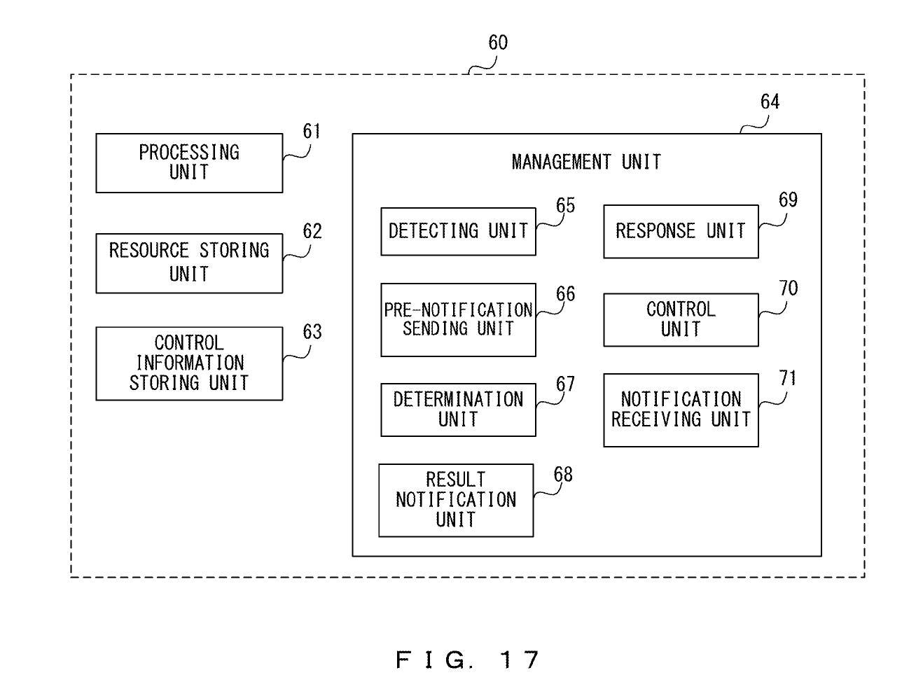

Next, details of the configuration of the data processing apparatus according to an embodiment are explained. FIG. 17 illustrates an example of the configuration of a data processing apparatus according to an embodiment.

In FIG. 17, a data processing apparatus 60 includes a processing unit 61, a resource storing unit 62, a control information storing unit 63, and a management unit 64.

The data processing apparatus 60 is an example of the data processing apparatus 2. The processing unit 61 is an example of the data processing unit 3. The management unit 64 is an example of the data processing managing unit 4.

The processing unit 61 receives a processing request for a transaction and executes processing for the transaction according to the received processing request.

The resource storing unit 62 stores resources. Resources are the data that are handled in transactions and that are accessed by the processing unit 61.

The control information storing unit 63 stores transaction management information, pre-notification management information, and performance information. The transaction management information is information for managing resources accessed by a transaction that is being executed in the data processing apparatus. The pre-notification management information is information about processing completion pre-notifications received by the data processing apparatus, which is information for managing a processing completion pre-notification for which a corresponding commit notification or rollback notification has not been received. The performance information is information that indicates the transaction processing performance of all the data processing apparatuses in the data processing system.

The management unit 64 includes a detection unit 65, an pre-notification sending unit 66, a determination unit 67, a result notification unit 68, a response unit 69, a control unit 70, and a notification receiving unit 71. Here, as the processes executed by the management unit 64, there are two processes, namely a process related to the transaction (hereinafter, referred to as the first transaction) for which the processing is executed in the local apparatus and a process related to the transaction (hereinafter, referred to as the second transaction) for which the processing is executed in another apparatus. The detection unit 65, the pre-notification sending unit 66, the determination unit 67, and the result notification unit 68 are related to the first transaction. The response unit 69, the control unit 70, and the notification receiving unit 71 are related to the second transaction.

The detection unit 65 is an example of the detection unit 5. The pre-notification sending unit 66 is an example of the notification unit 6. The determination unit 67 is an example of the determination unit 7. The response unit 69 is an example of the transmitting unit 8. The result notification unit 68 is an example of the fix notification transmitting unit 9. The control unit 70 is an example of the control unit 10.

The detection unit 65 detects the termination of the processing for the first transaction by the processing unit 61.

The pre-notification sending unit 66 transmits a processing completion pre-notification by multicast to the management unit 64 of the other data processing apparatuses when the detection unit 65 detects the termination of the processing of the first transaction. The processing completion pre-notification includes identification information for the first transaction, the start time of the first transaction, identification information for the processing target data accessed in the first transaction, and information of a difference before and after an update of the processing target data accessed in the first transaction.

The determination unit 67 determines whether to execute a commit or a rollback for the first transaction, according to the responses from the other data processing apparatuses with respect to the processing completion pre-notification sent by the pre-notification sending unit 66. The determination unit 67 then controls the processing unit 61 according to the determination result so as to execute a commit or a rollback for the first transaction.

The result notification unit 68 transmits a process fix notification that indicates that a commit or a rollback has been executed for the first transaction by multicast to the other data processing apparatuses. That is, when a commit has been executed for the first transaction, the result notification unit 68 transmits a commit notification that indicates that a commit has been executed for the first transaction. When a rollback has been executed for the first transaction, the result notification unit 68 transmits a rollback notification that indicates that a rollback has been executed for the first transaction.

The response unit 69 receives, from another data processing apparatus, a processing completion pre-notification corresponding to the second transaction executed in the other data processing apparatus. Then, the response unit 69 generates a response to the processing completion pre-notification according to the received processing completion pre-notification, the transaction management information, and the performance information. Details of the generation of the response are explained later. Then, the response unit 69 transmits the generated response by unicast to the transmission source of the processing completion pre-notification corresponding to the second transaction.

The control unit 70 performs an update of the transaction management information according to the state of transactions executed in the data processing apparatus. Meanwhile, the control unit 70 performs an update of the pre-notification management information according to the reception state for the processing completion pre-notification, the type of the response to the processing completion pre-notification, and the reception state for the process fix notification. Meanwhile, the control unit 70 controls the access to the same resource as a resource accessed in the second transaction, in the period from when the response to the processing completion pre-notification corresponding to the second transaction is transmitted until the process fix notification corresponding to the second transaction is received. Details of the access control are explained later.

The notification receiving unit 71 receives a commit notification or a rollback notification for the second transaction from another data processing apparatus. When the notification receiving unit 71 receives a commit notification the notification receiving unit 71 controls the processing unit 61 so as to update (commit) resources according to the content of the processing completion pre-notification for the second transaction. That is, the notification receiving unit 71 controls the processing unit 61 so as to reflect the post-update state of the resources updated in the second transaction in the corresponding resources of the local apparatus.

Next, the generation of the response to the processing completion pre-notification by the response unit 69 is explained. As described above, there are three types of responses in the embodiment, namely the OK response, the RETRY response and the PENDING response. The OK response is a response that indicates that a commit for the second transaction is feasible. The RETRY response is a response that indicates that a commit for the second transaction is not feasible, and that includes content for ordering the transmission source of the processing completion pre-notification to perform an immediate retry after the rollback of the second transaction. The PENDING response is a response that indicates that a commit for the second transaction is not feasible, and that includes content for ordering the transmission source of the processing completion pre-notification to execute another transaction in the period between the rollback of the second transaction and the start of the retry. The generation of these three types of responses is performed according to the processing completion pre-notification, the transaction management information, and the performance information. First, explanations are provided for the transaction management information and the performance information.

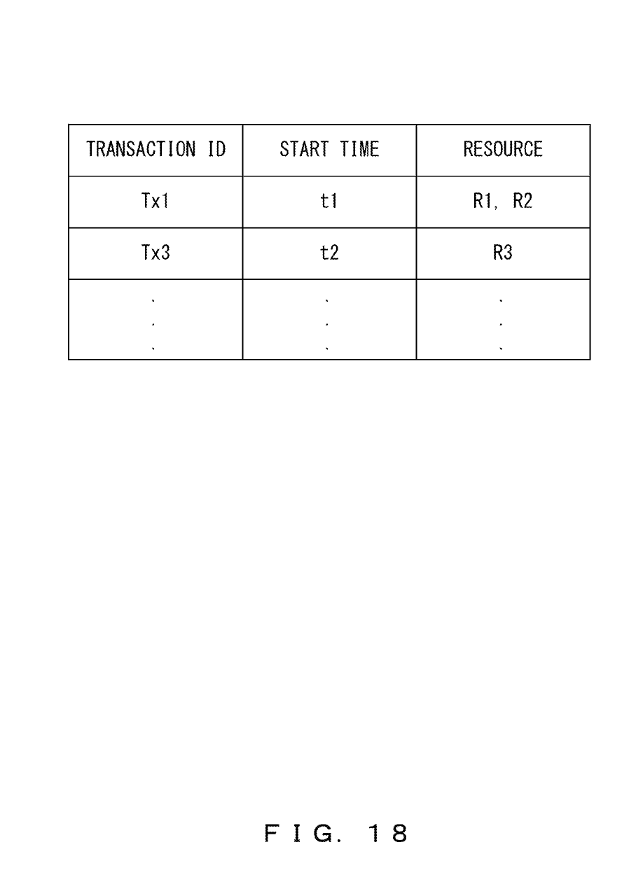

The transaction management information is management information about transactions that are being executed in the data processing apparatus. FIG. 18 illustrates an example of the configuration of the transaction management information. In FIG. 18, the transaction management information includes data items “transaction ID”, “start time”, and “resource”. The data items “transaction ID”, “start time”, and “resource” are associated and stored for each record. The “transaction ID” represents identification information for uniquely identifying a transaction that is being executed in the data processing apparatus. The “start time” represents the start time of the transaction indicated by the transaction ID. The “resource” represents identification information for the resources accessed in the transaction indicated by the transaction ID. Meanwhile, a plurality of resources may be accessed in one transaction.

The transaction management information is managed by the control unit 70. That is, when a transaction is started by the processing unit 61, the control unit 70 records information about the transaction that has been started in the transaction management information. In addition, when a commit or a rollback is executed for a transaction by the processing unit 61, the control unit 70 deletes information about the transaction from the transaction management information.

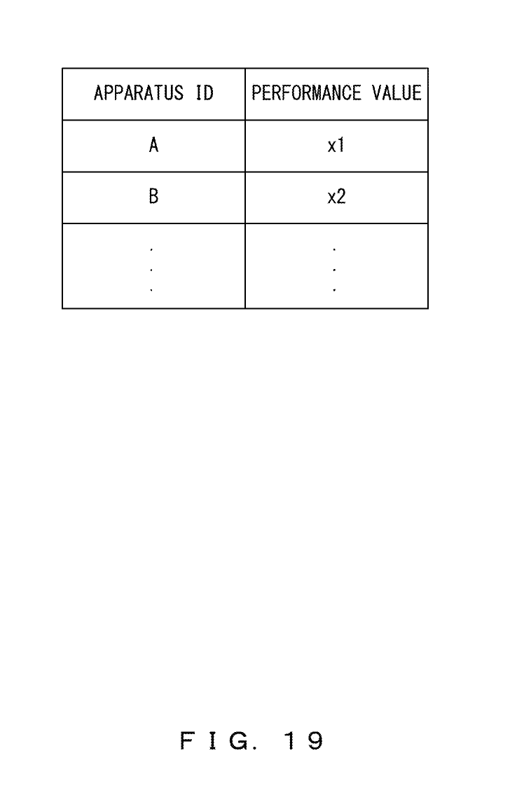

The performance information is information that indicates the transaction processing performance of all the data processing apparatuses in the data processing system. FIG. 19 illustrates an example of the configuration of the performance information. In FIG. 19, the performance information includes data items “apparatus ID” and “performance value”, and “apparatus ID” and “performance value” are associated and stored for each record. The “apparatus ID” represents identification information for uniquely identifying a data processing apparatus included in the data processing system. The “performance value” represents the value of the transaction processing performance of the processing unit 61 of the data processing apparatus indicated by the “apparatus ID”.

Next, the specific actions in the generation process for the response by the response unit 69 are explained. When the response unit 69 receives a processing completion pre-notification corresponding to the second transaction from another data processing apparatus, the response unit 69 determines whether there are any transactions that are being executed and that handle the same resource as a resource handled in the second transaction. The determination is made using the received processing completion pre-notification and the transaction management information.

When there are no transactions that are being executed and that handle the same resource as a resource handled in the second transaction, no conflicts occur between the second transaction and transactions being executed. Therefore, in this case, the response unit 69 generates an OK response that indicates that a commit for the second transaction is feasible, and transmits it to the transmission source of the processing completion pre-notification. Meanwhile, these actions are actions corresponding to the pattern 1 described earlier.

When there is a transaction that is being executed and that handles the same resource as a resource handled in the second transaction, a conflict occurs between the second transaction and the transaction being executed. In this case, in the data processing system, control is performed such that a rollback is executed for the transaction whose start time is later in the two transactions between which a conflict occurs, in order to prevent the emergence of inconsistency of data. For this purpose, first, the response unit 69 compares the second transaction and the transaction that is being executed and that handles the same resource as the resource handled in the second transaction, and identifies the transaction whose processing start time is later. Specifically, the response unit 69 obtains the processing start time of the second transaction from the processing completion pre-notification, and obtains the processing start time of the transaction that is being executed and that handles the same resource as the resource handled in the second transaction from the transaction management information. Then, the response unit 69 identifies the transaction whose processing start time is later by comparing the obtained start times of the two transactions.

When the response unit 69 determines that the transaction whose processing start time is later is the transaction that is being executed in the local apparatus, the response unit 69 generates an OK response and transmits it to the transmission source of the processing completion pre-notification. Then, the response unit 69 executes a rollback for the transaction that is being executed in the local apparatus, and after receiving a commit notification or a rollback notification for the second transaction, performs a retry for the rolled-back transaction. Meanwhile, these actions are actions corresponding to the pattern 2 described earlier.

On the other hand, when the response unit 69 determines that the transaction whose processing start time is later is the second transaction, the response unit 69 generates and transmits a RETRY response or a PENDING response that indicates that a commit for the second transaction is not feasible. Meanwhile, in this case, the processing of the transaction that is being executed in the local apparatus is continued.

Here, which of the RETRY response and the PENDING response is to be generated is determined according to the order of the transaction processing performances of the local apparatus and the other data processing apparatus that executes the second transaction. Specifically, the response unit 69 refers to the performance information and compares the transaction processing performances of the processing unit 61 of the local apparatus and the processing unit 61 of the data processing apparatus that executes the second transaction. When the processing performance of the local apparatus is equal to or higher than that of the data processing apparatus that executes the second transaction, the response unit 69 generates a RETRY response that orders an immediate retry for the second transaction and transmits it back to the transmission source of the processing completion pre-notification. Meanwhile, the response unit 69 generates the RETRY response such that it includes the identification information of the conflicting transaction. The reason for ordering an immediate retry in this way is that the processing of the transaction executed by the local apparatus with a high processing performance is likely to be completed in a short time and it is not likely that a conflict will occur again at the time of the immediate retry. Meanwhile, these actions are actions corresponding to the pattern 3 described earlier.

On the other hand, when the processing performance of the local apparatus is lower than that of the data processing apparatus that executes the second transaction, the response unit 69 generates a PENDING response and transmits it back to the transmission source of the processing completion pre-notification. The PENDING response is a response that includes content for ordering the transmission source of the processing completion pre-notification to execute another transaction in the period between the rollback of the second transaction and the start of the retry. The reason for ordering in this way is that the transaction executed by the local apparatus with a low processing performance is likely to need a long time until the completion of the processing, and it is likely that a conflict will occur again when an immediate retry is performed after the rollback. Therefore, by executing a transaction that handles a different resource in the period between the rollback and the start of the retry, it becomes possible to increase the processing efficiency for transactions. Meanwhile, these actions are actions corresponding to the fourth pattern described earlier.

Specifically, the response unit 69 generates the PENDING response such that it includes the identification information for the conflicting transaction and the identification information for the resource for which the conflict has occurred. The data processing apparatus that has received the PENDING response identifies a transaction that handles a resource that is different from the resource for which the conflict has occurred according to the identification information for the resource included in the PENDING response, and executes the transaction.

Next, the access control by the control unit 70 is explained in detail. Regarding the control access, it is performed by the control unit 70 according to the pre-notification management information. First, details of the pre-notification management information are explained.

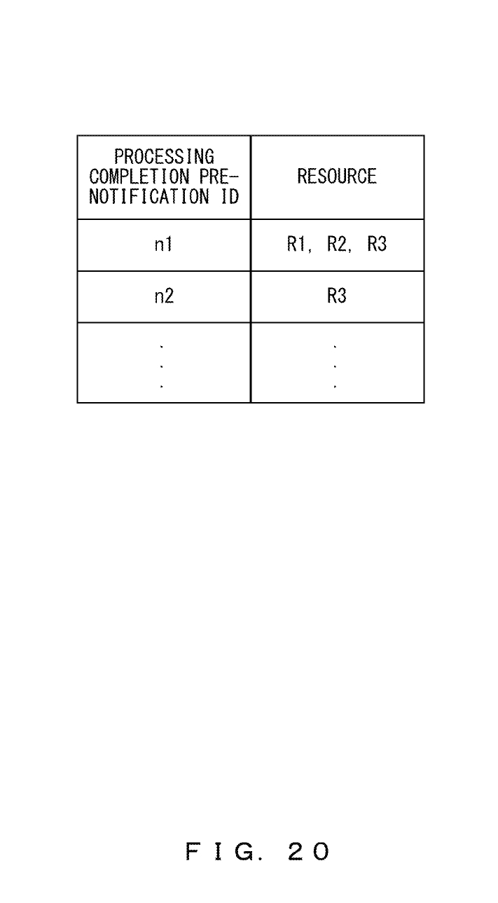

FIG. 20 illustrates an example of the configuration of the pre-notification management information. The pre-notification management information associates and stores the data items “processing completion pre-notification ID” and “resource” for each record. The “processing completion pre-notification ID” represents identification information for a processing completion pre-notification received by the local apparatus. The “resource” represents identification information of resources handled in the transaction corresponding to the processing completion pre-notification.

The pre-notification management information is managed by the control unit 70. That is, when the response unit 69 receives a processing completion pre-notification, the control unit 70 records information about the received processing completion pre-notification in the pre-notification management information. In addition, when the control unit 70 receives a commit notification or rollback information from another data processing apparatus, the control unit 70 deletes information about the processing completion pre-notification corresponding to these notifications from the pre-notification management information.

The access control by the control unit 70 is performed in the period from when an OK response to the processing completion pre-notification for the second transaction is received until a commit notification or a rollback notification for the second transaction is received. During this period, the control unit 70 temporarily restricts the access to the resource handled in the second transaction. That is, the control unit 70 controls the processing unit 61 so as to pause the processing of the transaction in which an access to the resource handled in the second transaction has occurred. Whether or not an access to the resource handled in the second transaction has occurred is determined using the pre-notification management information. Then, after receiving a commit notification or a rollback notification for the second transaction, the control unit 70 controls the processing unit 61 so as to cancel the restriction of the access, and to resume the processing of the transaction that has been paused. By so doing, it becomes possible to prevent the occurrence of inconsistency emerging after the transmission of the OK response. Meanwhile, these actions are actions corresponding to the first pattern-2 described above. Meanwhile, when an access to the resource handled in the second transaction occurs after the reception of a commit notification or the reception of a rollback notification, the control unit 70 does not perform the access control.

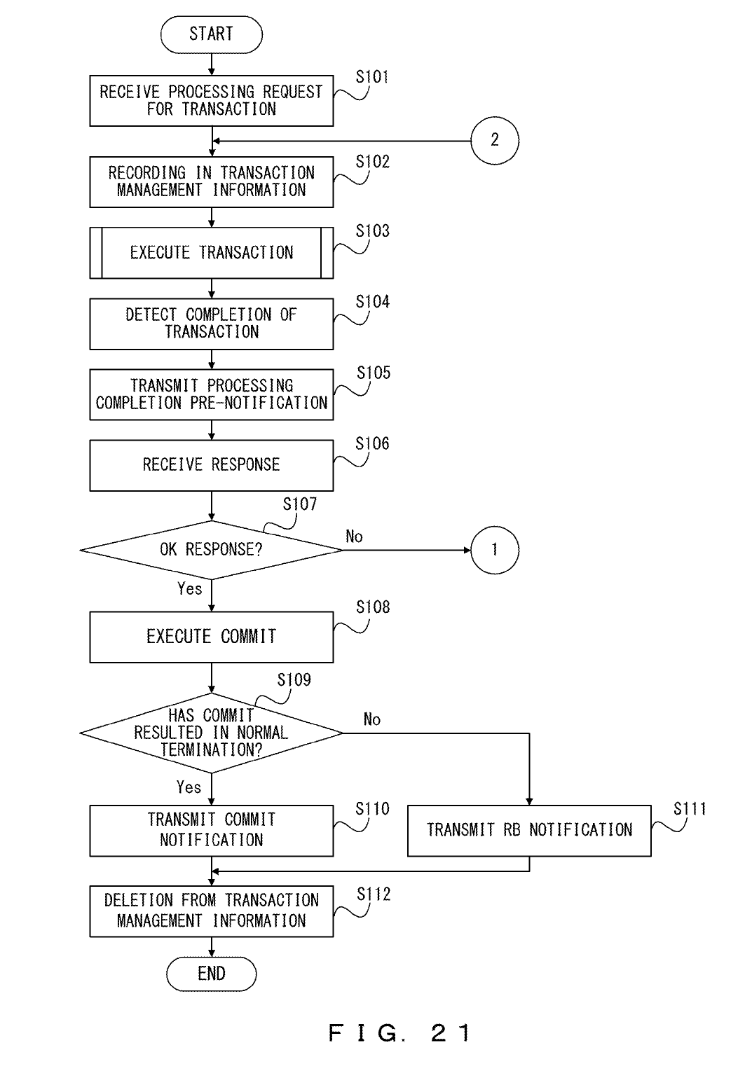

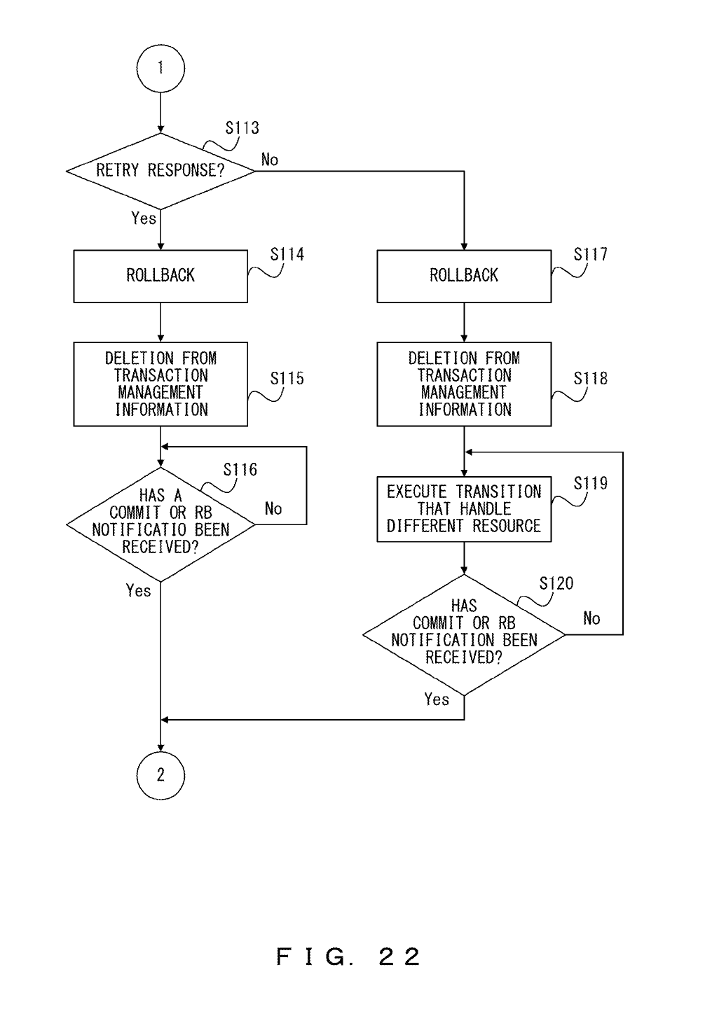

FIG. 21 and FIG. 22 are examples (1, 2) of a flowchart illustrating details of processing for the first transaction in the data processing apparatus according to an embodiment.

In FIG. 21, first, the processing unit 61 receives a processing request for the first transaction (S101). Next, the control unit 70 records information about the first transaction in the transaction management information (S102).

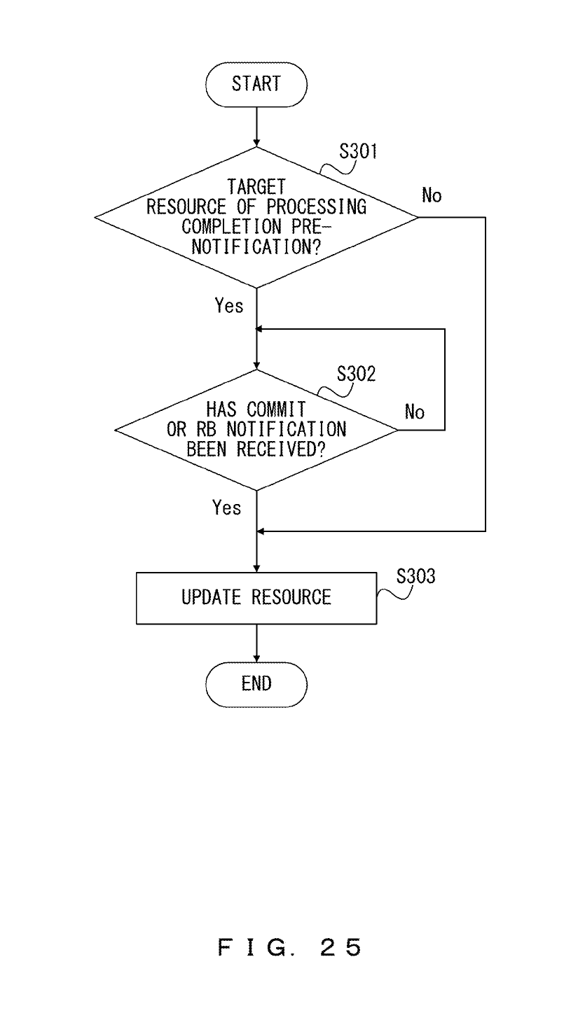

Next, the processing unit 61 executes the processing for the first transaction (S103). In S103, a process related to the access control explained later with reference in FIG. 25 is performed. Next, the detection unit 65 detects the termination of the processing for the first transaction (S104).

Next, the pre-notification sending unit 66 generates a processing completion pre-notification corresponding to the first transaction and transmits it by multicast to the other data processing apparatuses (S105). Next, the determination unit 67 receives, from another data processing apparatus, a response to the processing completion pre-notification transmitted in S105 (S106).

Next, the determination unit 67 determines whether or not the response received in S106 is an OK response (S107). When it is determined that the response received in S106 is not an OK response (S107, No), the process moves to S113 in FIG. 22. On the other hand, when it is determined that the response received in S106 is an OK response (S107, Yes), the determination unit 67 executes a commit for the first transaction by controlling the processing unit 61 (S108). Here, when the commit results in an abnormal termination, the processing unit 61 rolls back the first transaction.

Next, the result notification unit 68 determines whether or not the commit executed by the processing unit 61 has resulted in a normal termination (S109). When the result notification unit 68 determines that the commit executed by the processing unit 61 has resulted in a normal termination (S109, Yes), the result notification unit 68 transmits a commit notification to the other data processing apparatuses (5110). On the other hand, when the result notification unit 68 determines that the commit executed by the processing unit 61 has resulted in an abnormal termination (S109, No), the result notification unit 68 transmits a rollback notification (described as RB notification in the drawing) to the other data processing apparatuses (S111).

Next, the control unit 70 deletes information about the first transaction from the transaction management information (S112). Then, the processing is terminated.

When the determination unit 67 determines in S107 that the response is not an OK response (S107, No), the determination unit 67 determines whether or not the response received in S106 is a RETRY response (FIG. 22, S113). When it is determined that the response received in S106 is not a RETRY response (S113, No), that is, when it is determined that the received response is a PENDING response, the process moves to S117. On the other hand, when it is determined that the response received in S106 is a RETRY response (S113, Yes), the processing unit 61 executes a rollback for the first transaction (S114). Here, the explanation is provided assuming that a third transaction is indicated by the identification information included in the RETRY response about the transaction that conflicts with the first transaction.

Next, the control unit 70 deletes information about the first transaction from the transaction management information (S115). Next, the control unit 70 determines whether or not a commit or rollback notification about the third transaction has been received from the other data processing apparatuses (S116). When the control unit 70 determines that a commit or rollback notification about the third transaction has not been received (S116, No), the control unit 70 repeats the process of S116. On the other hand, when it is determined that a commit or rollback notification about the third transaction has been received (S116, Yes), the process moves to S102 in FIG. 21, and the processing of the first transaction from S102 is executed again.

When it is determined in S113 that the response is not a RETRY response (S113, No), that is, when it is determined in S113 that the response is a PENDING response, the processing unit 61 executes a rollback for the first transaction (S117). Here, the explanation is provided assuming that a third transaction is indicated by the identification information included in the PENDING response about the transaction that conflicts with the first.

Next, the control unit 70 deletes information about the first transaction from the transaction management information (S118).

Next, the control unit 70 performs control such that another transaction that does not handle the resource accessed in the third transaction is executed (S119). Specifically, the control unit 70 obtains, from the PENDING response, the identification information for resources handled in the third transaction. Then, the control unit 70 controls the processing unit 61 so as to execute a transaction that does not handle the resources indicated by the obtained identification information.

Next, the control unit 70 determines whether or not a commit or rollback notification with respect to the third transaction has been received from the other data processing apparatus (S120). When it is determined that a commit or rollback notification with respect to the third transaction has not been received (S120, No), the process moves to S119. On the other hand, when it is determined that a commit or rollback notification with respect to the third transaction has been received (S120, Yes), the process moves to S102 in FIG. 21, and the processing of the first transaction from S102 is executed again.

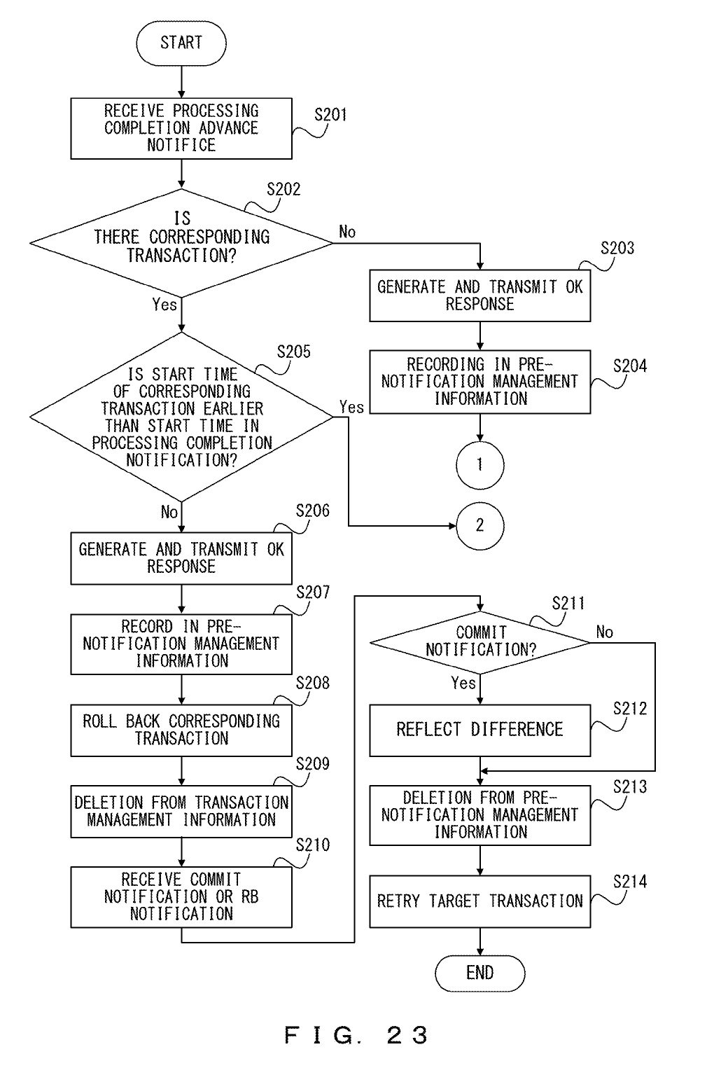

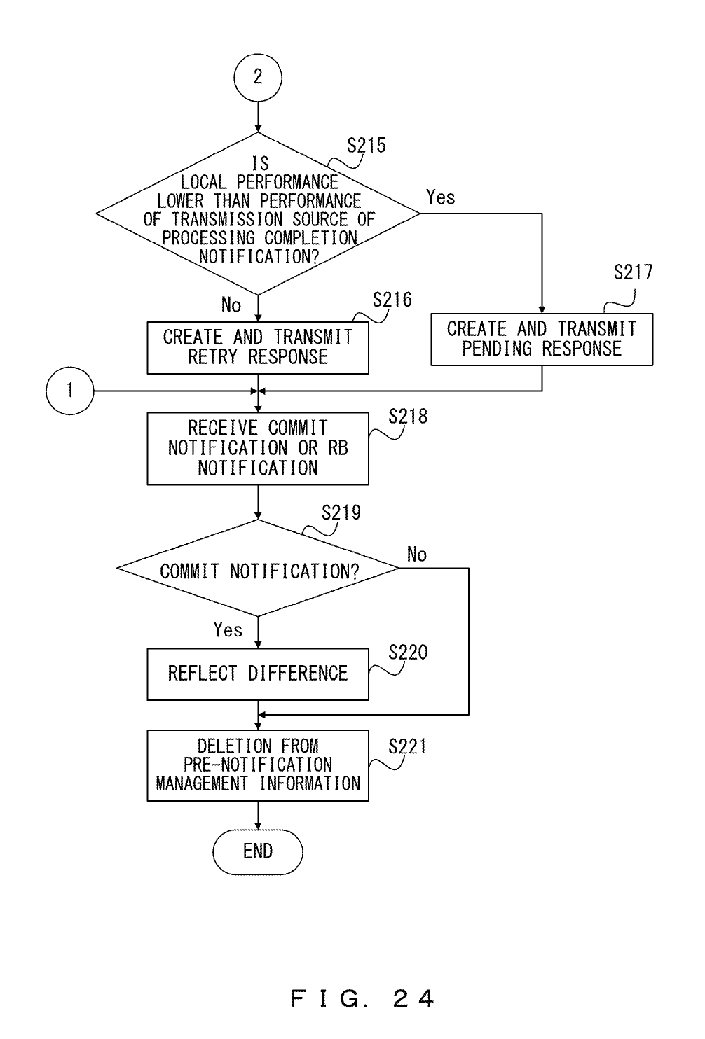

FIG. 23 and FIG. 24 are examples (1, 2) illustrating details of the processing for the second transaction in the data processing apparatus according to an embodiment.

In FIG. 23, first, the response unit 69 receives, from another data processing apparatus, a processing completion pre-notification for the second transaction (S201).

Next, the response unit 69 determines whether there are any transactions that are being executed and that handle the same resource as a resource handled in the second transaction (S202). Specifically, the response unit 69 obtains, from the processing completion pre-notification, the identification information for the processing target data accessed in the second transaction. Then, the response unit refers to the transaction management information to determine whether there are any records whose “resource” matches the identification information obtained from the processing completion pre-notification. In the explanation of the drawing below, the transaction that is being executed and that handles the same resource as a resource handled in the second transaction is referred to as the corresponding transaction.

When the response unit 69 determines that there are no corresponding transactions (S202, No), the response unit 69 generates an OK response and transmits it by unicast to the data processing apparatus that is the transmission source of the processing completion pre-notification (S203). The OK response includes information that indicates that a commit for the second transaction is feasible.

Next, the control unit 70 records information about the second transaction in the pre-notification management information, (S204). Then, the process moves on to S218 in FIG. 24.

When the response unit 69 determines in S202 that there are corresponding transactions (S202, Yes), the response unit 69 determines whether there is a corresponding transaction that was started earlier than the second transaction (S205). Specifically, the response unit 69 obtains, from the processing completion pre-notification, the information that indicates the start time of the second transaction. Then, the response unit 69 refers to the transaction management information to determine whether there is a record that is a record of a corresponding transaction and whose “start time” is a time that is earlier than the start time obtained from the processing completion pre-notification.

When it is determined that there is a transaction that was started earlier than the second transaction (S205, Yes), the process moves to S215 in FIG. 24. On the other hand, when the response unit 69 determines that there is no transaction that was started earlier than the second transaction (S205, No), the response unit 69 generates an OK response and transmits it by unicast to the data processing apparatus that is the transmission source of the processing completion pre-notification (S206).

Next, the control unit 70 records information about the second transaction in the pre-notification management information (S207).

Next, the control unit 70 controls the processing unit 61 to roll back the corresponding transaction (S208). Next, the control unit 70 deletes information about the corresponding transaction from the transaction management information (S209).

Next, the notification receiving unit 71 receives, from another data processing apparatus, a commit notification or a rollback notification corresponding to the second transaction (S210). Then, the notification receiving unit 71 determines whether the received notification is a commit notification or a rollback notification (S211).

When it is determined that a commit notification has not been received (S211, No), that is, when it is determined that a rollback notification has been received, the process moves to S213. On the other hand, when it is determined that a commit notification has been received (S211, Yes), the notification receiving unit 71 controls the processing unit 61 so as to update resources according to the content of the processing completion pre-notification received in S201 (S212). That is, the notification receiving unit 71 controls the processing unit 61 so as to update the post-update state of the resources in the second transaction reflected in the corresponding resources in the local apparatus.

Next, the control unit 70 deletes information about the second transaction from the pre-notification management information (S213). Next, the control unit 70 performs control so as to re-execute the corresponding transaction that was rolled back in S207 (S214). Then, the processing is terminated.

When the response unit 69 determines in S205 that there is a corresponding transaction that was started earlier than the second transaction (S205, Yes), the response unit 69 performs the following process. That is, the response unit 69 determines whether the transaction processing performance of the processing unit 61 of the local apparatus is lower than the transaction processing performance of the processing apparatus 61 of the data processing apparatus that executes the second transaction (S215 in FIG. 24). When the response unit 69 determines that the transaction processing performance of the processing unit 61 of the local apparatus is equal to or higher than the transaction processing performance of the processing apparatus 61 of the data processing apparatus that executes the second transaction (S215, No), the response unit 69 generates a RETRY response and transmits it by unicast to the data processing apparatus that is the transmission source of the processing completion pre-notification (S216). Then, the process moves to S218. On the other hand, when the response unit 69 determines that the transaction processing performance of the processing unit 61 of the local apparatus is lower than the transaction processing performance of the processing apparatus 61 of the data processing apparatus that executes the second transaction (S215, Yes), the response unit 69 performs the following process. That is, the response unit 69 generates a PENDING response and transmits it by unicast to the data processing apparatus that is the transmission source of the processing completion pre-notification (S217). Here, the processing related to the corresponding transaction is still continued after S216, S217.

Next, the notification receiving unit 71 receives, from another data processing apparatus, a commit notification or a rollback notification corresponding to the second transaction (S218). Then, the notification receiving unit 71 determines whether the received notification is a commit notification or a rollback notification (S219).

When it is determined that a commit notification has not been received (S219, No), that is, when it is determined that a rollback notification has been received, the process moves to S221. On the other hand, when it is determined that a commit notification has been received (S219, Yes), the notification receiving unit 71 controls the processing unit 61 so as to update resources according to the content of the processing completion pre-notification that was received in S201 (S220). That is, the notification receiving unit 71 controls the processing unit 61 so as to reflect the post-update state of the resources updated in the second transaction in the corresponding resources in the local apparatus.

Next, when information about the second transaction exists in the pre-notification management information, the control unit 70 deletes information about the second transaction (S221). Then, the processing is terminated.

FIG. 25 is an example of a flowchart illustrating details of the process of access control by the control unit 70. This process is the process executed in S103 in FIG. 21. In the explanation in FIG. 25, it is the process related to the second transaction. An explanation is provided for a case in which a prescribed transaction (explained as the first transaction) is executed during the execution of the processes of S203-S220 and S206-S212 in FIG. 23 and FIG. 24.

In FIG. 25, first, the control unit 70 determines whether or not a resource that is the access target (hereinafter, referred to as the access target resource) of the first transaction is a resource handled in the second transaction (S301). Specifically, the control unit 70 refers to the pre-notification management information to determine whether or not there is a record whose “resource” is the same as the access target resource.

When it is determined that the access target is not a resource handled in the second transaction (S301, No), the process moves to S303.

On the other hand, when it is determined that the access target is the resource handled in the second transaction (S301, Yes), the control unit 70 performs the following process. That is, the control unit 70 determines whether or not a commit notification or a rollback notification corresponding to the second transaction has been received (S302). Specifically, the control unit 70 refers to the pre-notification management information to determine whether or not there is a record in the pre-notification management information whose “resource” is the same as the access target resource.

When the control unit 70 determines that neither a commit notification nor a rollback notification corresponding the second transaction has been received (S302, No), the control unit 70 executes S302 again.

When the control unit 70 determines that a commit notification or a rollback notification corresponding the second transaction has been received (S302, Yes), the control unit 70 controls the processing unit 61 so as to perform an access to the access target resource in the first transaction (S303). Then, the process is terminated.

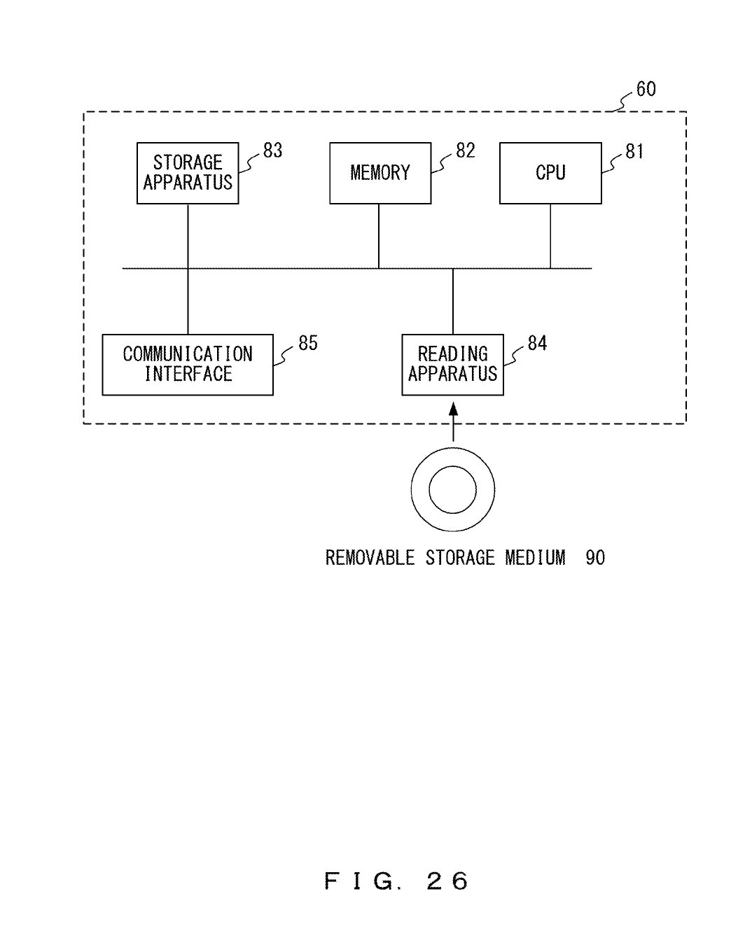

Next, an example of the hardware configuration of the data processing apparatus 60 is explained. FIG. 26 illustrates an example of the hardware configuration of the data processing apparatus according to an embodiment.

In FIG. 26, the data processing apparatus 60 includes a Central Processing Unit (CPU) 81, a memory 82, a storage apparatus 83, a reading apparatus 84, and a communication interface 85. The CPU 81, the memory 82, the storage apparatus 83, the reading apparatus 84, and the communication interface 85 are connected via a bus.

The CPU 81 provides a part or all of the functions of the processing unit 61 and the management unit 64 by using the memory 82 to execute a program in which the procedures in the flowcharts mentioned earlier are described.

The memory 82 is a semiconductor memory for example, which is configured to include a Random Access Memory (RAM) area and a Read Only Memory (ROM) area. The storage apparatus 83 is a hard disk for example. Meanwhile, the storage apparatus 83 may also be a semiconductor memory such as a Solid State Drive (SSD), a flash memory, or the like. In addition, the storage apparatus 83 may also be an external recording apparatus. When the data processing apparatus 60 is a cache server, the memory 82 provides a part or all of the functions of the resource storing unit 62 and the control information storing unit 63. When the data processing apparatus 60 is a DB server, the memory 82 provides apart or all of the functions of the control information storing unit 63, and the storage apparatus 83 provides a part or all of the functions of the resource storing unit 62. Meanwhile, when the data processing apparatus 60 is a cache server, data may all be managed on the memory 82, or may be managed on an SSD, a flash memory, or the like. Here, one of the main factors for a difference between the performances of the processing units 61 of the cache server and the DB server is that data of the cache server are usually managed in-memory, and data of the DB server is usually managed on-disk.

The reading apparatus 84 accesses a removable storage medium 90 according to instructions from the CPU 81. The removable storage medium 90 is realized by a semiconductor device (a USB memory or the like), a medium to and from which information is input and output by the magnetic action (a magnetic disk or the like), a medium to and from which information is input and output by the optical action (a CD-ROM, a DVD, or the like), or the like, for example. Meanwhile, the reading apparatus 84 does not have to be included in the data processing apparatus 60.

The communication interface 85 communicates via a network with another data processing apparatus and an apparatus (an AP server for example) that is the request source of a transaction, according to instructions from the CPU 81.

A program according to an embodiment is provided to the data processing apparatus 60 in the following formats, for example.

(1) Installed in the storage apparatus 83 in advance.
(2) Provided by the removable storage medium 90.
(3) Provided from a program server (not illustrated in the drawing) via the communication interface 85.

Furthermore, apart of the data processing apparatus 60 may be realized by hardware. Alternatively, the data processing apparatus of an embodiment may be realized by a combination of software and hardware.

Meanwhile, each of a plurality of functions of the data processing apparatus 60 may be realized by a virtual server or the like, and the plurality of functions may be executed in one information processing apparatus.

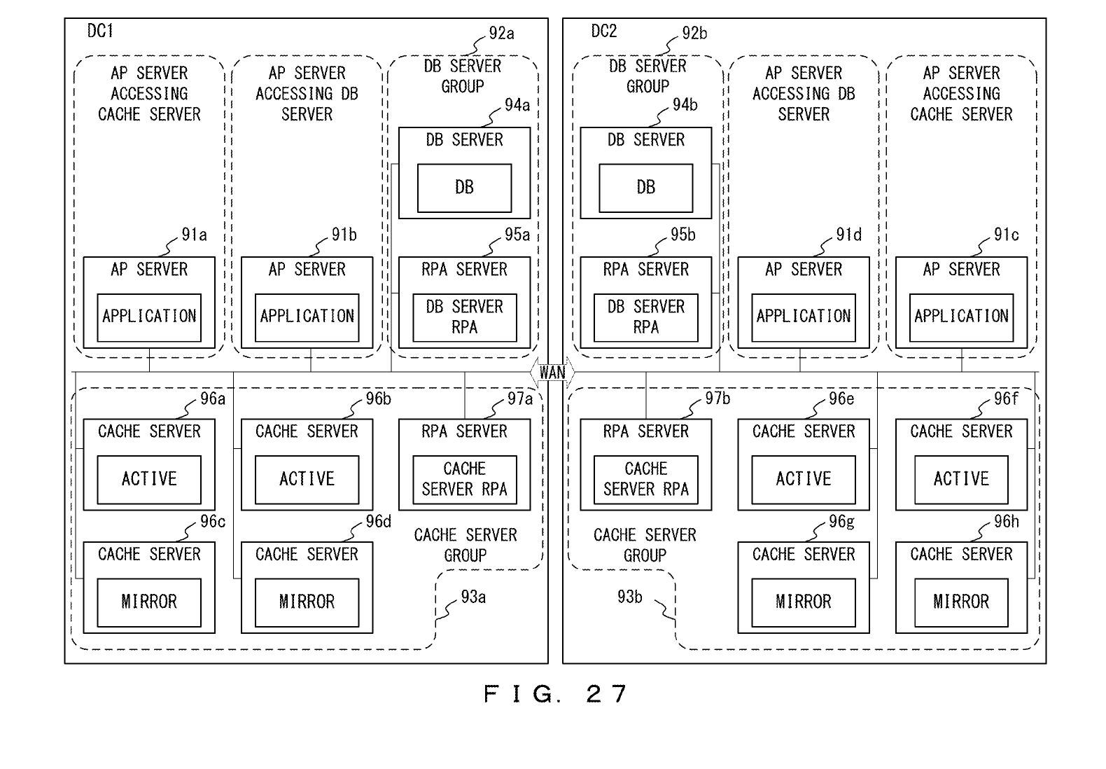

The data processing apparatus 2 in FIG. 4 is not limited to the configuration of one process per one machine, and may be in the logical unit in which a plurality of servers are put together. That is, a part or the entirety of the data processing apparatuses 2 (2a-2c) may be a system that includes one or a plurality of information processing apparatuses that provide the functions of the data processing unit 3 and an information processing apparatus that provides the functions of the data processing managing unit 4. An example of such a configuration is explained below. FIG. 27 illustrates an example of the configuration of the data processing system according to an embodiment.

In FIG. 27, the data processing system includes a DC1 and a DC2. The DC1 and the DC2 are connected via a communication network such as a WAN or the like. Each DC includes AP servers 91 (91a-91b, 91c-91d), a DB server group 92 (92a, 92b), and a cache server group 93(93a, 93b). The AP servers 91, the DB server groups 92, and the cache server group 93 in each DC are connected via a communication network such as a Local Area Network (LAN) or the like. While an explanation is provided about the DC1 here, the DC2 is similar to the DC1.

The AP server 91 executes an application for accessing the cache server group 92 or the DB server group 93.

The DB server group 92 as a whole provides functions corresponding to one data processing apparatus 60 in FIG. 17. The DB server group 92 includes one or a plurality of DB servers 94 (94a) that provide the functions or the processing unit 61 and the resource storing unit 62, and an RPA server 95 (95a) that provides the functions of the control information storing unit 63 and the management unit 64.

The cache server group 93 as a whole provides functions corresponding to one data processing apparatus 60 in FIG. 17. One or a plurality of cache servers 96 (96a-96d) that provide the functions of the processing unit 61 and the resource storing unit 62, and an RPA server (97a) that provides the functions of the control information storing unit 63 and the management unit 64 are included. The cache server 96 may operate as an in-memory database. For example, in the cache server 96, data related to transactions with the resource storing unit 62 and the AP servers may all be managed on the main memory. In addition, a configuration may also be made such that the data in the resource storing unit 62 are duplicated and stored in a distributed manner in a plurality of cache servers 96. Meanwhile, as illustrated in FIG. 27, the cache servers 96 may include cache servers 96a, 96b on the active side that receive connection from the AP server 91 and execute transactions, and cache servers 96c, 96d on the mirror side that perform mirroring of the data on the active side.

The hardware configuration of each of the DB servers 94, the RPA server 95, the cache servers 96, and the RPA server 97 is similar to that illustrated in FIG. 26. However, in the DB server 94, the CPU 81 provides the functions of the processing unit 61, and the storage apparatus 83 provides the functions of the resource storing unit 62. In addition, in the cache server 96, the CPU 81 provides the functions of the processing unit 61, and the memory 82 provides the functions of the resource storing unit 62. In addition, in the RPA servers 95, 97, the CPU 81 provides the functions of the management unit 64, and the memory 82 provides the functions of the control information storing unit 63.

Meanwhile, some or all of the DB servers 94, the RPA server 95, the cache servers 96, and the RPA server 97 may be realized by a virtual server. In addition, the functions of the RPA server of the DB server group 92 (the functions of the control information storing unit 63 and the management unit 64) may be configured to be provided by one of the DB servers 94 in the same DC. In this case, the RPA server 95 does not have to be in the same DC. Furthermore, the functions of the RPA server 97 of the cache server group 93 (the functions of the control information storing unit 63 and the management unit 64) may be configured to be provided by one of the cache servers 96 in the same DC. In this case, the RPA server 97 does not have to be in the same DC.

Meanwhile embodiments are not limited to the embodiments described above, and various configurations and embodiments are possible without departing from the gist of the present invention.

Meanwhile, in the embodiments, the example of the DB server and the cache server is explained as an example of the data processing apparatus for the sake of illustration, but the data processing apparatus may also be an information processing apparatus that provides prescribed functions. For example, the same approach may be applied not only to the DB server but also to any System of Record (SOR). In addition, between the caches and between SORs, they do not have to be configured with the same products, and the same approach may be applied between different products.

According to an aspect, in a system in which data are updated in a linked manner between a plurality of data processing apparatuses, it becomes possible to provide a data processing apparatus that executes another process without waiting for the completion of the execution of processing in another data processing apparatus.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a data processing management program executed by a computer in a data processing system including a plurality of data processing apparatuses each of which includes a data processing unit and executes a data processing management program that operates in an associated manner with the data processing unit, respectively, the data processing units of the respective data processing apparatuses performing data updating in a linked manner in the data processing system, the data processing management program causing the computer to execute a process comprising:
detecting a completion of a first process with respect to a first processing request to a corresponding data processing unit;
sending, according to the detection, a first processing completion pre-notification that includes a processing start time of the first process and information about processing target data of the first process to each of other management processes executed by other data processing management programs in the computer or in a specific data processing apparatus that is one of the plurality of data processing apparatuses;
determining whether or not it is feasible to commit the first process, according to a response content with respect to the first processing completion pre-notification from each of a plurality of the management processes; and
generating and transmitting, when a second processing completion pre-notification is received from one of the plurality of management processes, a response to the second processing completion pre-notification according to whether or not, in the corresponding data processing unit, each of the processes started in the corresponding data processing unit earlier than a processing start time specified from the second processing completion pre-notification is targeted at processing target data specified from the second processing completion pre-notification and also according to performance information stored in the first data processing apparatus for a data processing unit corresponding to the management process that transmits the second processing completion pre-notification.

2. The non-transitory computer-readable recording medium according to claim 1, wherein
the first processing completion pre-notifications are sent by multicast communication.

3. The non-transitory computer-readable recording medium according to claim 1, the process further including:
when receiving a notification from the management process indicating that any of the processes started in one of the plurality of data processing apparatuses earlier than the processing start time of the first process specified from the first processing completion pre-notification is targeted at the processing target data specified from the first processing completion notification, controlling the corresponding data processing unit so as to set the processing target data back to a state before the first process started.

4. The non-transitory computer-readable recording medium according to claim 3, wherein
when receiving a notification from the management process indicating that any of the processes started in one of the plurality of data processing apparatuses earlier than the processing start time of the first process specified from the first processing completion pre-notification is targeted at the processing target data specified from the first processing completion pre-notification and that a performance of the corresponding data processing unit is equal to or higher than a performance of a data processing unit in the one of the plurality of data processing apparatus, the controlling controls the corresponding data processing unit so as to set the processing target data back to a state before the first process started and to re-execute the first process after executing a third process targeted at data that are different from the processing target data of the second process.

5. The non-transitory computer-readable recording medium according to claim 1, the process further including:
when it is determined that it is feasible to commit the first process, controlling the data processing unit so as to execute a committing process for the first process, and transmitting, to other data processing managing programs, a commit notification that indicates that the first process has been committed; and
in a case in which it is determined that, in the corresponding data processing unit, each of the processes started in the corresponding data processing unit earlier than a processing start time specified from the second processing completion pre-notification is not targeted at processing target data specified from the second processing completion pre-notification and a request is generated for an access to the processing target data specified from the second processing completion pre-notification after transmitting a response to the second processing completion pre-notification, controlling the corresponding data processing unit so as to make the access after receiving the commit notification corresponding to the second process and executing a committing process for the second process.

6. An information processing apparatus in a data processing system including a plurality of data processing apparatuses each of which includes a data processing unit and a data processing managing unit that operates in an associated manner with the data processing unit, respectively, the data processing units of the respective data processing apparatuses performing data updating in a linked manner in the data processing system, the information processing apparatus comprising;
the data processing managing unit that executes a process including:
detecting a completion of a first process with respect to a first processing request to a corresponding data processing unit;
sending, according to the detection, a first processing completion pre-notification that includes a processing start time of the first process and information about processing target data of the first process to each of other data processing managing units in a specific data processing apparatus that is one of the plurality of data processing apparatuses;
determining whether or not it is feasible to commit the first process, according to a response content with respect to the first processing completion pre-notification from each of a plurality of the data processing managing units; and
generating and transmitting, when a second processing completion pre-notification is received from one of the plurality of data processing managing units, a response to the second processing completion pre-notification according to whether or not, in the corresponding data processing unit, each of the processes started in the corresponding data processing unit earlier than a processing start time specified from the second processing completion pre-notification is targeted at processing target data specified from the second processing completion pre-notification and also according to performance information stored in the first data processing apparatus for a data processing unit corresponding to the data processing managing unit that transmits the second processing completion pre-notification.

7. A data processing system including a plurality of data processing apparatuses each of which includes a data processing unit and a data processing managing unit that operates in an associated manner with the data processing unit, respectively, the data processing units of the respective data processing apparatuses performing data updating in a linked manner in the data processing system, wherein
a first data processing managing unit of a first data processing apparatus executes a process including:
detecting a completion of a first process with respect to a first processing request to a first data processing unit corresponding to the first data processing managing unit;
sending, according to the detection, a first completion pre-notification that includes a processing start time of the first process and information about processing target data of the first process to each of other data processing managing units in the first data processing apparatus or in a specific data processing apparatus that is one of the plurality of data processing apparatuses; and
determining whether or not it is feasible to commit the first process, according to a response content with respect to the first processing completion pre-notification from each of a plurality of the data processing managing units, and
a second data processing managing unit of a second data processing apparatus executes a process including:
generating and transmitting, when the processing completion pre-notification for the first process is received from the first data processing managing unit, a response to the first processing completion pre-notification according to whether or not, in a second data processing unit corresponding to the second data processing managing unit, each of the processes started in the second data processing unit earlier than a processing start time specified from the first processing completion pre-notification is targeted at processing target data specified from the first processing completion pre-notification and also according to performance information for the first data processing unit stored in the second data processing apparatus.

8. A data processing management method executed in a data processing apparatus in a data processing system including a plurality of data processing apparatuses each of which includes a data processing unit and a data processing managing unit that operates in an associated manner with the data processing unit, respectively, the data processing units of the respective data processing apparatuses performing data updating in a linked manner in the data processing system, the data processing management method comprising:
detecting, by the data processing managing unit, a completion of a first process with respect to a first processing request to a corresponding data processing unit;
sending, by the data processing managing unit, according to the detection, a first processing completion pre-notification that includes a processing start time of the first process and information about processing target data of the first process to each of other data processing managing units in a specific data processing apparatus that is one of the plurality of data processing apparatuses;
determining, by the data processing managing unit, whether or not it is feasible to commit the first process, according to a response content with respect to the first processing completion pre-notification from each of a plurality of the data processing managing units; and
generating and transmitting, by the data processing managing unit, when a second processing completion pre-notification is received from one of the plurality of data processing managing units, a response to the second processing completion pre-notification according to whether or not, in the corresponding data processing unit, each of the processes started in the corresponding data processing unit earlier than a processing start time specified from the second processing completion pre-notification is targeted at processing target data specified from the second processing completion pre-notification and also according to performance information stored in the first data processing apparatus for a data processing unit corresponding to the data processing managing unit that transmits the second processing completion pre-notification.
